(19) United States
(12) Patent Application Publication
(10) Pub. No.: US 2009/0092312 A1
(43) Pub. Date: Apr. 9, 2009

(54) Identifying Method and Storage Medium Having Program Stored Thereon

(75) Inventors: Hirokazu Kasahara, Okaya-shi (JP); Tsuneo Kasai, Azumino-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/244,636

(22) Filed: Oct. 2, 2008

(30) Foreign Application Priority Data
Oct. 5, 2007 (JP) 2007-262126

(51) Int. Cl. G06K 9/64

(52) U.S. Cl. 382/159

(57) ABSTRACT

An identification processing that matches a preference of a user is carried out. An identifying method according to the present invention is an identifying method, in which learning is carried out using a learning sample and, based on a learning result, identification is performed as to whether or not a target of identification belongs to a certain class, including: extracting a learning sample belonging to the certain class and a learning sample not belonging to the certain class, displaying a plurality of the extracted learning samples arranged on a display section, as well as displaying a mark between the learning sample belonging to the certain class and the learning sample not belonging to the certain class, and displaying the mark between a different pair of the learning samples by moving a position of the mark in response to an instruction of a user, changing an attribute information that indicates a class to which the learning sample belongs in response to the position of the mark determined by the user, and identifying whether or not a target of identification belongs to the certain class based on a result of relearning using the learning sample of which the attribute information has been changed.

### CROSS-REFERENCE TO RELATED APPLICATIONS

The present application claims priority upon Japanese Patent Application No. 2007-262126 filed on Oct. 5, 2007 which is herein incorporated by reference.

### BACKGROUND

1. Technical Field

The present invention relates to identifying methods and storage media having programs stored thereon.

2. Related Art

Some digital still cameras have mode setting dials for setting the shooting mode. When a user sets a shooting mode using the dial, the digital still camera determines shooting conditions (such as exposure time) according to the shooting mode and takes a picture. When the picture is taken, the digital still camera generates an image file. This image file contains image data of a photographed image and supplemental data of, for example, the shooting conditions when photographing the image, which is appended to the image data.

It is also possible to use the supplemental data to identify a category (class) of image indicated by the image data. However, in this case, identifiable categories are limited to the types of data recorded in the supplemental data. For this reason, the image data may also be analyzed to identify the category of image indicated by the image data (see JP H10-302067A and JP 2006-511000A).

Sometimes the result of the identification processing may not match the preferences of a user. In this case, it is preferable for settings of the identification processing to be changed to match the preferences of the user.

### SUMMARY

The present invention has been devised in light of these circumstances and it is an advantage thereof to carry out an identification processing that matches the preferences of the user.

In order to achieve the above-described advantage, a primary aspect of the invention is directed to an identifying method, in which learning is carried out using a learning sample and, based on a learning result, identification is performed as to whether or not a target of identification belongs to a certain class, including: extracting a learning sample belonging to the certain class and a learning sample not belonging to the certain class, displaying a plurality of the extracted learning samples arranged on a display section, as well as displaying a mark between the learning sample belonging to the certain class and the learning sample not belonging to the certain class, and displaying the mark between a different pair of the learning samples by moving a position of the mark in response to an instruction of a user, changing an attribute information that indicates a class to which the learning sample belongs in response to the position of the mark determined by the user, and identifying whether or not a target of identification belongs to the certain class based on a result of relearning using the learning sample of which the attribute information has been changed.

Other features of the invention will become clear through the explanation in the present specification and the description of the accompanying drawings.

### BRIEF DESCRIPTION OF THE DRAWINGS

For a more complete understanding of the invention and the advantages thereof, reference is now made to the following description taken in conjunction with the accompanying drawings wherein:

FIG. 1 is an explanatory diagram of an image processing system;

FIG. 2 is an explanatory diagram of a configuration of a printer;

FIG. 3 is an explanatory diagram of an automatic correction function of the printer;

FIG. 4 is an explanatory diagram of the relationship between scenes of images and correction details;

FIG. 5 is a flow diagram of a scene identification processing by a scene identifying section;

FIG. 6 is an explanatory diagram of functions of the scene identifying section;

FIG. 7 is a flow diagram of overall identification processing;

FIG. 8 is an explanatory diagram of an-identification target table;

FIG. 9 is an explanatory diagram of a positive threshold in the overall identification processing;

FIG. 10 is an explanatory diagram of Recall and Precision;

FIG. 11 is an explanatory diagram of a first negative threshold;

FIG. 12 is an explanatory diagram of a second negative threshold;

FIG. 13A is an explanatory diagram of a threshold table; FIG. 13B is an explanatory diagram of thresholds in a landscape identifying section; FIG. 13C is an explanatory diagram of an outline of processing with the landscape identifying section;

FIG. 14 is a flowchart of partial identification processing;

FIG. 15 is an explanatory diagram of the order in which partial images are selected by an evening scene partial identifying section;

FIG. 16 shows graphs of Recall and Precision when an evening scene image is identified using only the top-ten partial images;

FIG. 17A is an explanatory diagram of discrimination using a linear support vector machine; FIG. 17B is an explanatory diagram of discrimination using a kernel function;

FIG. 18 is a flow diagram of integrative identification processing;

FIG. 19 is an explanatory diagram of a settings screen according to the first embodiment;

FIG. 20A shows data groups of learning samples stored in the memory 23; FIG. 20B is an explanatory diagram of a distribution of each learning samples;

FIG. 21A is an explanatory diagram of how a representative sample is projected onto a normal line of a border (f(x)=0);

FIG. 21B is an explanatory diagram of representative samples that have been projected onto a normal line;

FIG. 22A is an explanatory diagram of a data group after being changed; FIG. 22B is an explanatory diagram of a border after being changed;

FIG. 23 is an explanatory diagram of a settings screen according to a second embodiment;

FIG. 24A shows data groups of learning samples stored in the memory 23; FIG. 24B is an explanatory diagram of a distribution of each learning samples;

FIG. 25A is an explanatory diagram of a border F_ls(x)=0 that separates landscape images and evening scene images; FIG. 25B is an explanatory diagram of how a representative sample is projected onto a normal line of the border (F_ls(x)=0); FIG. 25C is an explanatory diagram of representative samples that have been projected onto a normal line;

FIG. 26A is an explanatory diagram of a data group after being changed; FIG. 26B is an explanatory diagram of a border after being changed;

FIG. 27 is an explanatory diagram showing how positions of two border setting bars are changed;

FIG. 28A is an explanatory diagram of a result of changing the position of a uppermost border setting bar 163A; FIG. 28B is an explanatory diagram of a result of changing the position of a second level border setting bar 163B; and FIG. 28C is a schematic diagram of a result of changing the positions of the two level border setting bars.

### DESCRIPTION OF EXEMPLARY EMBODIMENTS

At least the following matters will be made clear by the explanation in the present specification and the description of the accompanying drawings.

An identifying method, in which learning is carried out using a learning sample and, based on a learning result, identification is performed as to whether or not a target of identification belongs to a certain class, including:

extracting a learning sample belonging to the certain class and a learning sample not belonging to the certain class,

displaying a plurality of the extracted learning samples arranged on a display section, as well as displaying a mark between the learning sample belonging to the certain class and the learning sample not belonging to the certain class, and displaying the mark between a different pair of the learning samples by moving a position of the mark in response to an instruction of a user,

changing an attribute information that indicates a class to which the learning sample belongs in response to the position of the mark determined by the user, and

identifying whether or not a target of identification belongs to the certain class based on a result of relearning using the learning sample of which the attribute information has been changed will be made clear.

According to this identifying method, an identification processing can be carried out that matches the preferences of the user.

It is preferable that the extracting includes extracting a learning sample belonging to the certain class and a learning sample belonging to a different class from the certain class, and that an identification processing that identifies whether or not a target of identification belongs to the certain class and an identification processing that identifies whether or not a target of identification belongs to the different class are changed by the relearning. With this configuration, an identification processing can be carried out that matches the preferences of the user.

It is preferable that in the changing an attribute, in a case where the position of the mark has been determined in a state in which the learning sample belonging to the certain class is positioned between the mark and the learning sample belonging to the different class, the attribute information of the learning sample belonging to the certain class positioned between the mark and the learning sample belonging to the different class is changed so as to be not belonging to the certain class, and that in a case where the position of the mark has been determined in a state in which the learning sample belonging to the different class is positioned between the mark and the learning sample belonging to the certain class, the attribute information of the learning sample belonging to the different class positioned between the mark and the learning sample belonging to the certain class is changed so as to be not belonging to the different class. With this configuration, the attribute information can be changed to match the preferences of the user without a contradiction arising.

It is preferable that the extracting includes extracting a learning sample as a representative from each clusters that have undergone clustering, and that the changing an attribute includes, in a case the attribute information of a representative learning sample is changed, the attribute information of a learning sample belonging to a same cluster as that learning sample is also changed. With this configuration, attribute information of a plurality of learning samples can be changed collectively.

It is preferable that the learning sample is projected onto a normal line of a hyperplane that separates a learning sample belonging to the certain class and a learning sample belonging to the different class, and a learning sample to be extracted is determined based on a position of the learning sample that has been projected onto the normal line. Or, it is preferable that the identification processing identifies whether or not the target of identification belongs to the certain class based on a hyperplane that separates a space, and that in the extracting, the learning sample is projected onto a normal line of the hyperplane, and a learning sample to be extracted is determined based on a position of the learning sample that has been projected onto the normal line. With this configuration, learning samples can be extracted in order of high certainty factors.

A storage medium having a program stored thereon will be made clear, the program causing an identifying apparatus, in which learning is carried out using a learning sample and, based on a learning result, performs identification as to whether or not a target of identification belongs to a certain class, to perform:

extracting a learning sample belonging to the certain class and a learning sample not belonging to the certain class,

displaying a plurality of the extracted learning samples arranged on a display section as well as, displaying a mark between the learning sample belonging to the certain class and the learning sample not belonging to the certain class, and displaying the mark between a different pair of the learning samples by moving a position of the mark in response to an instruction of a user,

changing attribute information that indicates a class to which the learning sample belongs in response to the position of the mark determined by the user, and

identifying whether or not the target of identification belongs to the certain class based on a result of relearning using the learning sample of which the attribute information has been changed.

With a storage medium having such a program stored thereon, identification processing that matches the preferences of the user can be realized on an identifying apparatus.

Overall Explanation

First, an explanation on the basic configuration and processing of the identification processing will be given. Thereafter, the present embodiment will be described in detail.

Overall Configuration

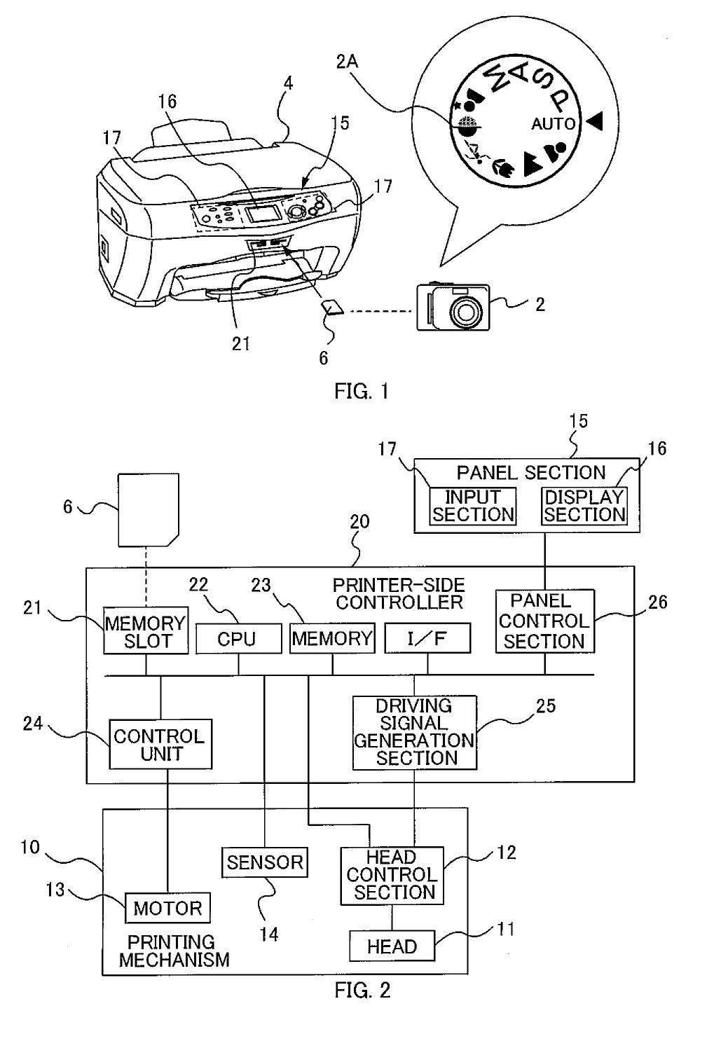

FIG. 1 is an explanatory diagram of an image processing system. This image processing system includes a digital still camera 2 and a printer 4.

The digital still camera 2 is a camera that captures a digital image by forming an image of a subject onto a digital device (such as a CCD). The digital still camera 2 is provided with a mode setting dial 2A. The user can set a shooting mode according to the shooting conditions using the dial 2A. For example, when the “night scene” mode is set with the dial 2A, the digital still camera 2 makes the shutter speed long or increases the ISO sensitivity to take a picture with shooting conditions suitable for photographing a night scene.

The digital still camera 2 saves an image file, which has been generated by taking a picture, on a memory card 6 in conformity with the file format standard. The image file contains not only digital data (image data) about an image photographed but also supplemental data about, for example, the shooting conditions (shooting data) at the time when the image was photographed.

The printer 4 is a printing apparatus for printing the image represented by the image data on paper. The printer 4 is provided with a slot 21 into which the memory card 6 is inserted. After taking a picture with the digital still camera 2, the user can remove the memory card 6 from the digital still camera 2 and insert the memory card 6 into the slot 21.

The panel section 15 includes a display section 16 and an input section 17 that has various kinds of buttons. This panel section 15 functions as a user interface. The display section 16 is configured with a liquid crystal display. If the display section 16 is of a touch panel type, the display section 16 also functions as the input section 17. The display section 16 has displayed thereon a setting screen for setting the printer 4, images of image data read from a memory card, a screen for acknowledging or alarming the user and the like. Note that various kinds of screens displayed on the display section 16 will be described later.

FIG. 2 is an explanatory diagram of a configuration of the printer 4. The printer 4 includes a printing mechanism 10 and a printer-side controller 20 for controlling the printing mechanism 10. The printing mechanism 10 has ahead 11 for ejecting ink, a head control section 12 for controlling the head 11, a motor 13 for, for example, transporting paper, and a sensor 14. The printer-side controller 20 has the memory slot 21 for sending/receiving data to/from the memory card 6, a CPU 22, a memory 23, a control unit 24 for controlling the motor 13, and a driving signal generation section 25 for generating driving signals (driving waveforms). In addition, the printer-side controller 20 also includes a panel control section 26 that controls the panel portion 15.

When the memory card 6 is inserted into the slot 21, the printer-side controller 20 reads out the image file saved on the memory card 6 and stores the image file in the memory 23. Then, the printer-side controller 20 converts image data in the image file into print data to be printed by the printing mechanism 10 and controls the printing mechanism 10 based on the print data to print the image on paper. A sequence of these operations is called “direct printing.”

It should be noted that “direct printing” not only is performed by inserting the memory card 6 into the slot 21, but also can be performed by connecting the digital still camera 2 to the printer 4 via a cable (not shown).

An image file stored on the memory card 6 is constituted by image data and supplemental data. The image data is constituted by a plurality of units of pixel data. The pixel data is data indicating color information (tone value) of each pixel. An image is made up of pixels arranged in a matrix form. Accordingly, the image data is data representing an image. The supplemental data includes data indicating the properties of the image data, shooting data, thumbnail image data, and the like.

Outline of Automatic Correction Function

When “portrait” pictures are printed, there is a demand for beautiful skin tones. Moreover, when “landscape” pictures are printed, there is a demand that the blue color of the sky should be emphasized and the green color of trees and plants should be emphasized. Thus, the printer 4 has an automatic correction function of analyzing the image file and automatically performing appropriate correction processing.

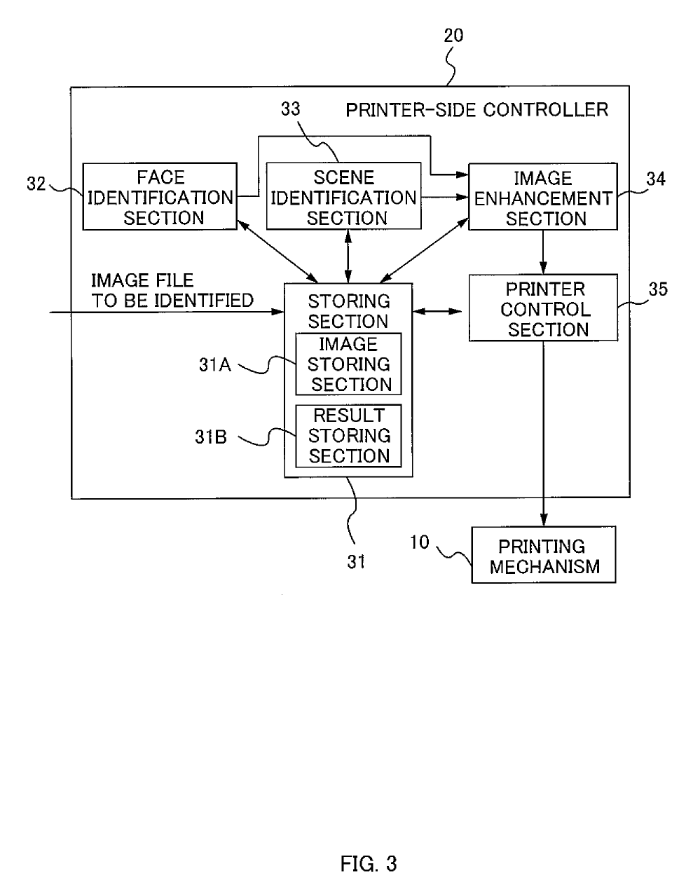

FIG. 3 is an explanatory diagram of the automatic correction function of the printer 4. Each component of the printer-side controller 20 in the diagram is realized with software and hardware.

A storing section 31 is realized with a certain area of the memory 23 and the CPU 22. All or a part of the image file that has been read out from the memory card 6 is expanded in an image storing section 31A of the storing section 31. The results of operations performed by the components of the printer-side controller 20 are stored in a result storing section 31B of the storing section 30.

A face identification section 32 is realized with the CPU 22 and a face identification program stored in the memory 23. The face identification section 32 analyzes the image data stored in the image storing section 31A and identifies whether or not there is a human face. When the face identification section 32 identifies that there is a human face, the image to be identified is identified as belonging to “portrait” scenes. In this case, a scene identification section 33 does not perform scene identification processing. Since the face identification processing performed by the face identification section 32 is similar to the processing that is already widespread, a detailed description thereof is omitted.

The scene identification section 33 is realized with the CPU 22 and a scene identification program stored in the memory 23. The scene identification section 33 analyzes the image file stored in the image storing section 31A and identifies the scene of the image represented by the image data. The scene identification section 33 performs the scene identification processing when the face identification section 32 identifies that there is no human face. As described later, the scene identification section 33 identifies which of “landscape,” “evening scene,” “night scene,” “flower,” “autumnal,” and “other” images the image to be identified is.

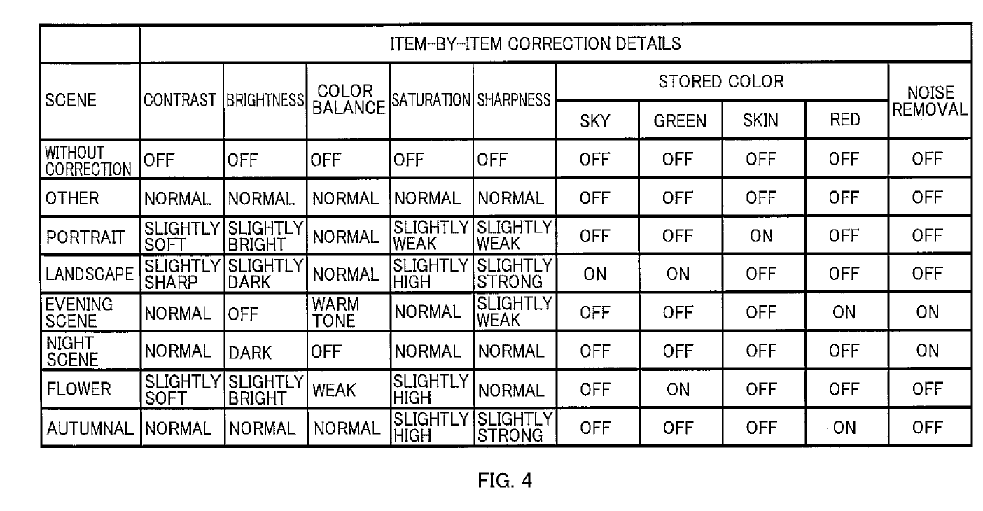

FIG. 4 is an explanatory diagram of the relationship between the scenes of images and correction details.

An image enhancement section 34 is realized with the CPU 22 and an image correction program stored in the memory 23. The image enhancement section 34 corrects the image data in the image storing section 31A based on the identification result (result of identification performed by the face identification section 32 or the scene identification section 33) that has been stored in the result storing section 31B of the storing section 31. For example, when the identification result of the scene identification section 33 is “landscape,” the image data is corrected so that blue and green are emphasized. It should be noted that the image enhancement section 34 may correct the image data not only based on the identification result about the scene but also reflecting the contents of the shooting data in the image file. For example, when negative exposure compensation was applied, the image data may be corrected so that a dark image is prevented from being brightened.

The printer control section 35 is realized with the CPU 22, the driving signal generation section 25, the control unit 24, and a printer control program stored in the memory 23. The printer control section 35 converts the corrected image data into print data and makes the printing mechanism 10 print the image.

Scene Identification Processing

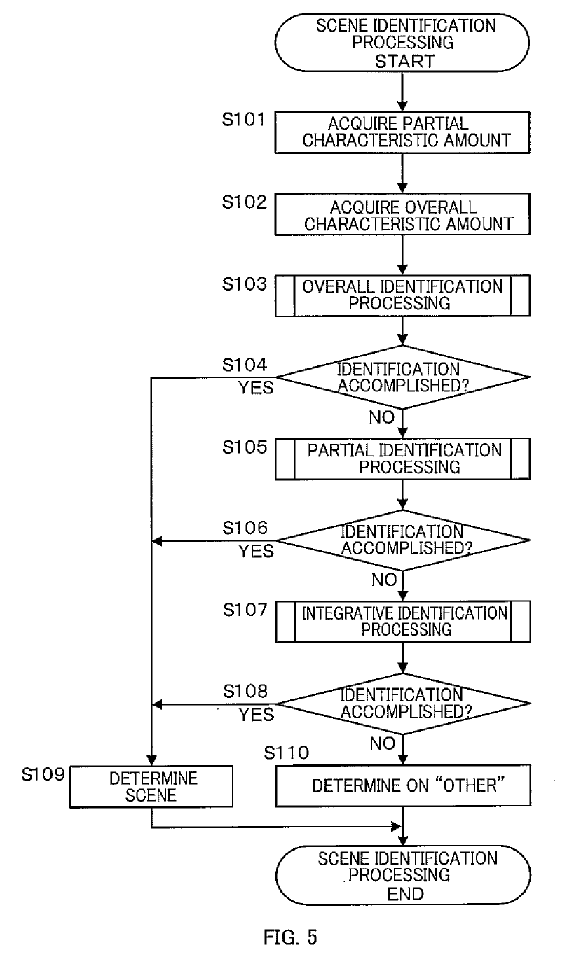

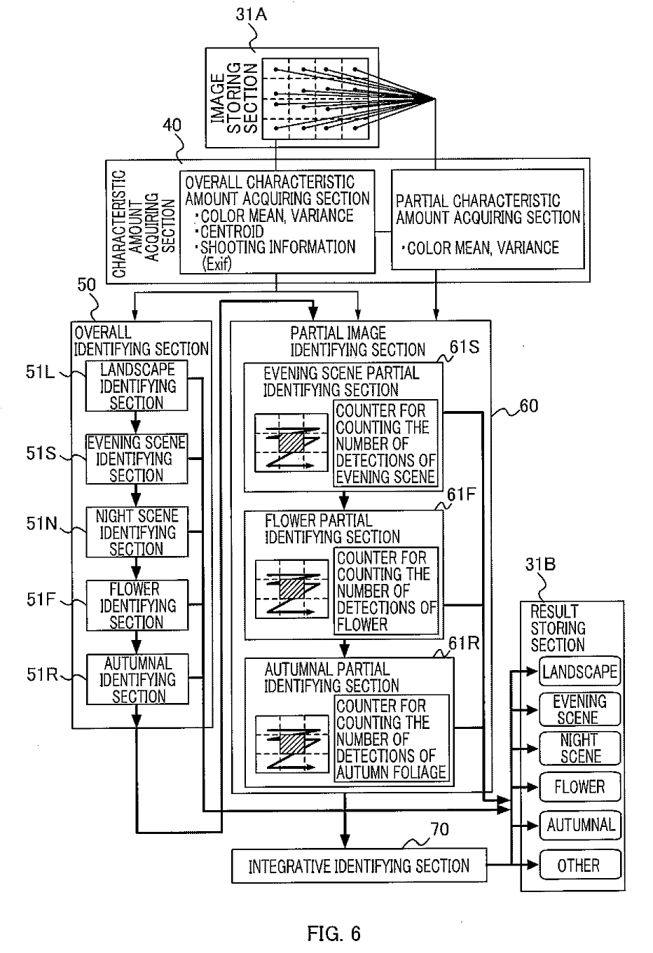

FIG. 5 is a flow diagram of the scene identification processing performed by the scene identification section 33. FIG. 6 is an explanatory diagram of functions of the scene identification section 33. Each component of the scene identification section 33 shown in the diagram is realized with software and hardware. The scene identification section 33 includes a characteristic amount acquiring section 40, an overall identifying section 50, a partial identifying section 60 and an integrative identifying section 70, shown in FIG. 6.

First, a characteristic amount acquiring section 40 analyzes the image data expanded in the image storing section 31A of the storing section 31 and acquires partial characteristic amounts (S101). Specifically, the characteristic amount acquiring section 40 divides the image data into 8×8=64 blocks, calculates color means and variances of the blocks, and acquires the calculated color means and variances as partial characteristic amounts. It should be noted that every pixel here has data about a tone value in the YCC color space, and a mean value of Y, a mean value of Cb, and a mean value of Cr are calculated for each block and a variance of Y, a variance of Cb, and a variance of Cr are calculated for each block. That is to say, three color means and three variances are calculated as partial characteristic amounts for each block. The calculated color means and variances indicate features of a partial image in each block. It should be noted that it is also possible to calculate mean values and variances in the RGB color space.

Since the color means and variances are calculated for each block, the characteristic amount acquiring section 40 expands portions of the image data corresponding to the respective blocks in a block-by-block order without expanding all of the image data in the image storing section 31A. For this reason, the image storing section 31A may not necessarily have as large a capacity as all of the image data can be expanded.

Next, the characteristic amount acquiring section 40 acquires overall characteristic amounts (S102). Specifically, the characteristic amount acquiring section 40 acquires color means and variances, a centroid, and shooting information of the entire image data as overall characteristic amounts. It should be noted that the color means and variances indicate features of the entire image. The color means, variances, and the centroid of the entire image data are calculated using the partial characteristic amounts acquired in advance. For this reason, it is not necessary to expand the image data again when calculating the overall characteristic amounts, and thus the speed at which the overall characteristic amounts are calculated is increased. It is because the calculation speed is increased in this manner that the overall characteristic amounts are obtained after the partial characteristic amounts although overall identification processing (described later) is performed before partial identification processing (described later). It should be noted that the shooting information is extracted from the shooting data in the image file. Specifically, information such as the aperture value, the shutter speed, and whether or not the flash is fired, is used as the overall characteristic amounts. However, not all of the shooting data in the image file is used as the overall characteristic amounts.

Next, an overall identifying section 50 performs the overall identification processing (S103). The overall identification processing is processing for identifying (estimating) the scene of the image represented by the image data based on the overall characteristic amounts. A detailed description of the overall identification processing is provided later.

When the scene can be identified by the overall identification processing (“YES” in S104), the scene identification section 33 determines the scene by storing the identification result in the result storing section 31B of the storing section 31 (S109) and terminates the scene identification processing. That is to say, when the scene can be identified by the overall identification processing (“YES” in S104), the partial identification processing and integrative identification processing are omitted. Thus, the speed of the scene identification processing is increased.

When the scene cannot be identified by the overall identification processing (“No” in S104), a partial identifying section 60 then performs the partial identification processing (S105). The partial identification processing is processing for identifying the scene of the entire image represented by the image data based on the partial characteristic amounts. A detailed description of the partial identification processing is provided later.

When the scene can be identified by the partial identification processing (“YES” in S106), the scene identification section 33 determines the scene by storing the identification result in the result storing section 31B of the storing section 31 (S109) and terminates the scene identification processing. That is to say, when the scene can be identified by the partial identification processing (“YES” in S106), the integrative identification processing is omitted. Thus, the speed of the scene identification processing is increased.

When the scene cannot be identified by the partial identification processing (“NO” in S106), an integrative identifying section 70 performs the integrative identification processing (S107). A detailed description of the integrative identification processing is provided later.

When the scene can be identified by the integrative identification processing (“YES” in S108), the scene identification section 33 determines the scene by storing the identification result in the result storing section 31B of the storing section 31 (S109) and terminates the scene identification processing. On the other hand, when the scene cannot be identified by the integrative identification processing (“NO” in S108), the identification result that the image represented by the image data is an “other” scene (scene other than “landscape,” “evening scene,” “night scene,” “flower,” or “autumnal”) is stored in the result storing section 31B (S110).

Overall Identification Processing

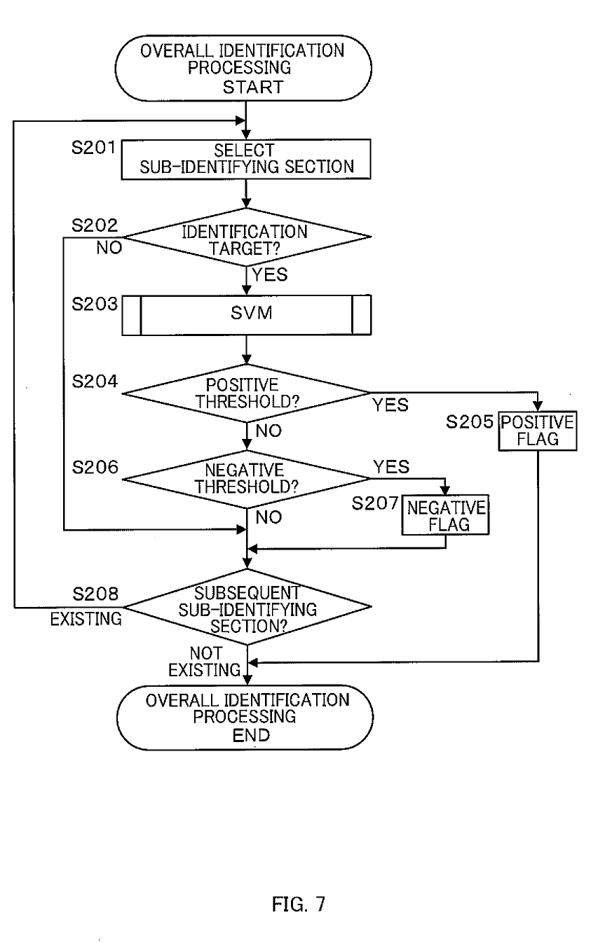

FIG. 7 is a flow diagram of the overall identification processing. Here, the overall identification processing is described also with reference to FIG. 6.

First, the overall identifying section 50 selects one sub-identifying section 51 from a plurality of sub-identifying sections 51 (S201). The overall identifying section 50 is provided with five sub-identifying sections 51 that identify whether or not the image serving as a target of identification (image to be identified) belongs to a specific scene. The five sub-identifying sections 51 identify landscape, evening scene, night scene, flower, and autumnal scenes, respectively. Here, the overall identifying section 50 selects the sub-identifying sections 51 in the order of landscape→evening scene→night scene→flower→autumnal. (Note that a description on the order in which the sub-identifying sections 51 are selected is provided later.) For this reason, at the start, the sub-identifying section 51 (landscape identifying section 51L) for identifying whether or not the image to be identified belongs to landscape scenes is selected.

Next, the overall identifying section 50 references an identification target table and determines whether or not to identify the scene using the selected sub-identifying section 51 (S202).

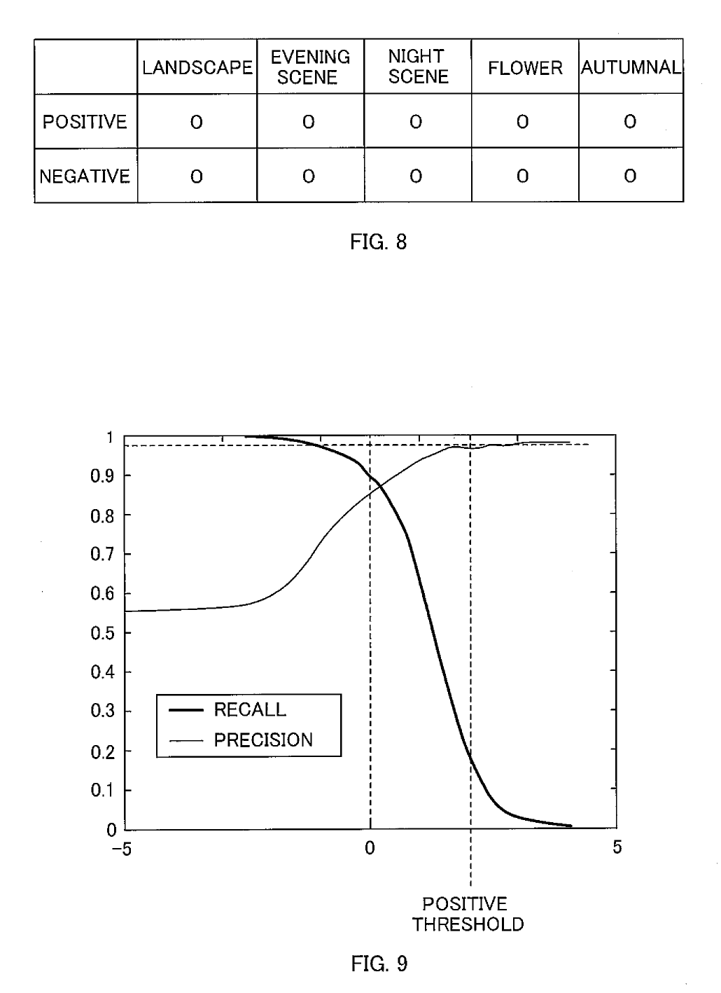

FIG. 8 is an explanatory diagram of the identification target table. This identification target table is stored in the result storing section 31B of the storing section 31. At the first stage, all the fields in the identification target table are set to zero. In the process of S202, a “negative” field is referenced, and when this field is zero, it is determined “YES,” and when this field is 1, it is determined “NO.” Here, the overall identifying section 51 references the “negative” field under the “landscape” column to find that this field is zero and thus determines “YES.”

Next, the sub-identifying section 51 calculates a value (certainty factor) according to the probability that the image to be identified belongs to a specific scene based on the overall characteristic amounts (S203). The sub-identifying sections 51 employ an identification method using a support vector machine (SVM). A description of the support vector machine is provided later. When the image to be identified belongs to a specific scene, the discriminant equation of the sub-identifying section 51 is likely to be a positive value. When the image to be identified does not belong to a specific scene, the discriminant equation of the sub-identifying section 51 is likely to be a negative value. Moreover, the higher the probability that the image to be identified belongs to a specific scene is, the larger the value of the discriminant equation is. Accordingly, a large value of the discriminant equation indicates a high probability (certainty factor) that the image to be identified belongs to a specific scene, and a small value of the discriminant equation indicates a low probability that the image to be identified belongs to a specific scene.

Next, the sub-identifying section 51 determines whether or not the value of the discriminant equation is larger than a positive threshold (S204). When the value of the discriminant equation is larger than the positive threshold, the sub-identifying section 51 determines that the image to be identified belongs to a specific scene.

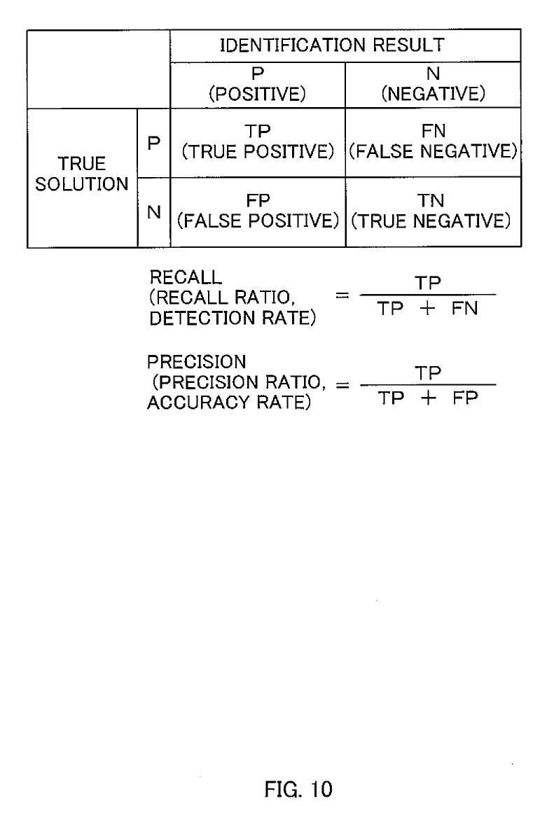

FIG. 9 is an explanatory diagram of the positive threshold in the overall identification processing. In this diagram, the vertical axis represents the positive threshold, and the horizontal axis represents the probability of Recall or Precision. FIG. 10 is an explanatory diagram of Recall and Precision. When the value of the discriminant equation is equal to or more than the positive threshold, the identification result is taken as Positive, and when the value of the discriminant equation is not equal to or more than the positive threshold, the identification result is taken as Negative.

Recall indicates the recall ratio or a detection rate. Recall is the proportion of the number of images identified as belonging to a specific scene in the total number of images of the specific scene. In other words, Recall indicates the probability that, when the sub-identifying section 51 is made to identify an image of a specific scene, the sub-identifying section 51 identifies Positive (the probability that the image of the specific scene is identified as belonging to the specific scene). For example, Recall indicates the probability that, when the landscape identifying section 51L is made to identify a landscape image, the landscape identifying section 51L identifies the image as belonging to landscape scenes.

Precision indicates the precision ratio or an accuracy rate. Precision is the proportion of the number of images of a specific scene in the total number of images identified as Positive. In other words, Precision indicates the probability that, when the sub-identifying section 51 for identifying a specific scene identifies an image as Positive, the image to be identified is the specific scene. For example, Precision indicates the probability that, when the landscape identifying section 51L identifies an image as belonging to landscape scenes, the identified image is actually a landscape image.

As can be seen from FIG. 9, the larger the positive threshold is, the greater Precision is. Thus, the larger the positive threshold is, the higher the probability that an image identified as belonging to, for example, landscape scenes is a landscape image is. That is to say, the larger the positive threshold is, the lower the probability of misidentification is.

On the other hand, the larger the positive threshold is, the smaller Recall is. As a result, for example, even when a landscape image is identified by the landscape identifying section 51L, it is difficult to correctly identify the image as belonging to landscape scenes. When the image to be identified can be identified as belonging to landscape scenes (“YES” in S204), identification with respect to the other scenes (such as evening scenes) is no longer performed, and thus the speed of the overall identification processing is increased. Therefore, the larger the positive threshold is, the lower the speed of the overall identification processing is. Moreover, since the speed of the scene identification processing is increased by omitting the partial identification processing when scene identification can be accomplished by the overall identification processing (S104), the larger the positive threshold is, the lower the speed of the scene identification processing is.

That is to say, too small a positive threshold will result in a high probability of misidentification, and too large a positive threshold will result in a decreased processing speed. Here, the positive threshold for landscapes is set to 1.27 in order to set the precision ratio (Precision) to 97.5%.

When the value of the discriminant equation is larger than the positive threshold (“YES” in S204), the sub-identifying section 51 determines that the image to be identified belongs to a specific scene, and sets a positive flag (S205). “Set a positive flag” refers to setting a “positive” field in FIG. 8 to 1. In this case, the overall identifying section 50 terminates the overall identification processing without performing identification by the subsequent sub-identifying sections 51. For example, when an image can be identified as a landscape image, the overall identifying section 50 terminates the overall identification processing without performing identification with respect to evening scenes and the like. In this case, the speed of the overall identification processing can be increased because identification by the subsequent sub-identifying sections 51 is omitted.

When the value of the discriminant equation is not larger than the positive threshold (“NO” in S204), the sub-identifying section 51 cannot determine that the image to be identified belongs to a specific scene, and performs the subsequent process of S206.

Then, the sub-identifying section 51 compares the value of the discriminant equation with a negative threshold (S206). Based on this comparison, the sub-identifying section 51 determines whether or not the image to be identified belongs to a predetermined scene. Such a determination is made in two ways. First, when the value of the discriminant equation of the sub-identifying section 51 with respect to a certain specific scene is smaller than a first negative threshold, it is determined that the image to be identified does not belong to that specific scene. For example, when the value of the discriminant equation of the landscape identifying section 51L is smaller than the first negative threshold, it is determined that the image to be identified does not belong to landscape scenes. Second, when the value of the discriminant equation of the sub-identifying section 51 with respect to a certain specific scene is larger than a second negative threshold, it is determined that the image to be determined does not belong to a scene different from that specific scene. For example, when the value of the discriminant equation of the landscape identifying section 51L is larger than the second negative threshold, it is determined that the image to be identified does not belong to night scenes.

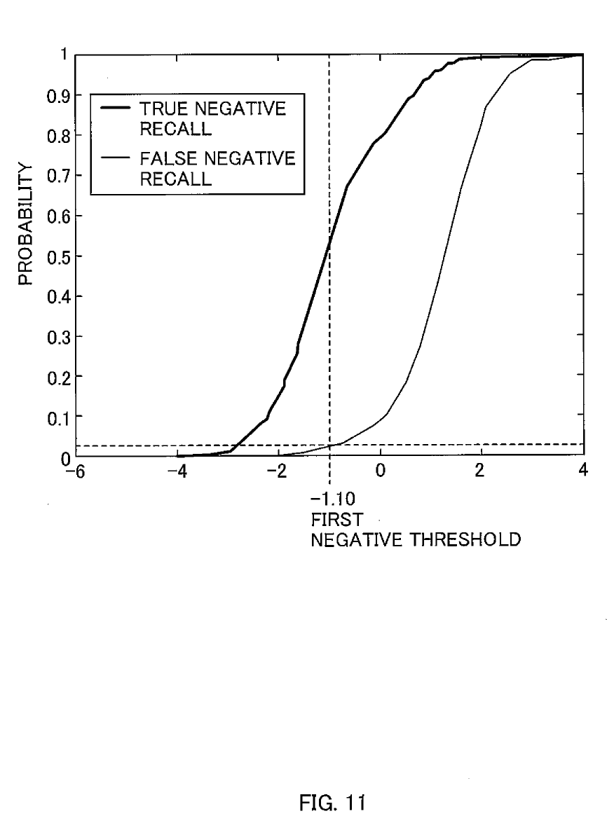

FIG. 11 is an explanatory diagram of the first negative threshold. In this diagram, the horizontal axis represents the first negative threshold, and the vertical axis represents the probability. The graph shown by a bold line represents True Negative Recall and indicates the probability that an image that is not a landscape image is correctly identified as not being a landscape image. The graph shown by a thin line represents False Negative Recall and indicates the probability that a landscape image is misidentified as not being a landscape image.

As can be seen from FIG. 11, the smaller the first negative threshold is, the smaller False Negative Recall is. Thus, the smaller the first negative threshold is, the lower the probability that an image identified as not belonging to, for example, landscape scenes is actually a landscape image becomes. In other words, the probability of misidentification decreases.

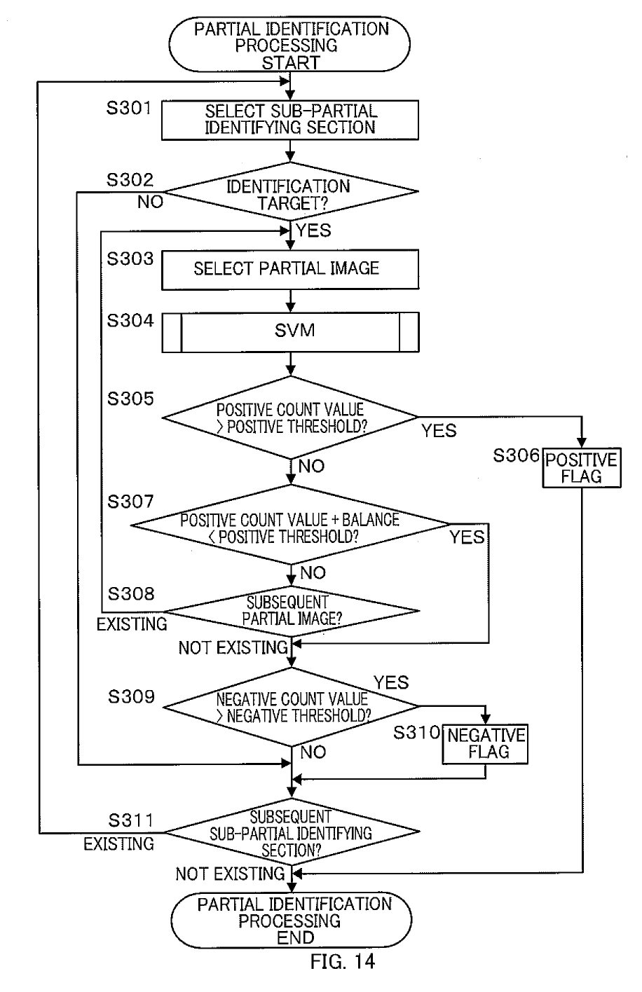

On the other hand, the smaller the first negative threshold is, the smaller True Negative Recall also is. As a result, an image that is not a landscape image is less likely to be identified as a landscape image. Meanwhile, when the image to be identified can be identified as not being a specific scene, processing by a sub-partial identifying section 61 with respect to that specific scene is omitted during the partial identification processing, thereby increasing the speed of the scene identification processing (described later, S302 in FIG. 14). Therefore, the smaller the first negative threshold is, the lower the speed of the scene identification processing is.

That is to say, too large a first negative threshold will result in a high probability of misidentification, and too small a first negative threshold will result in a decreased processing speed. Here, the first negative threshold is set to −1.10 in order to set False Negative Recall to 2.5%.

When the probability that a certain image belongs to landscape scenes is high, the probability that this image belongs to night scenes is inevitably low. Thus, when the value of the discriminant equation of the landscape identifying section 51L is large, it may be possible to identify the image as not being a night scene. In order to perform such identification, the second negative threshold is provided.

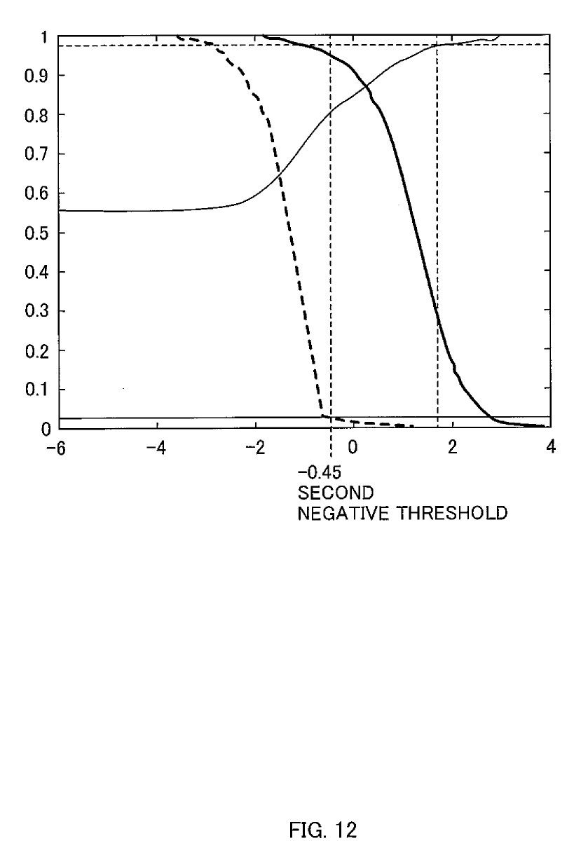

FIG. 12 is an explanatory diagram of the second negative threshold. In this diagram, the horizontal axis represents the value of the discriminant equation with respect to landscapes, and the vertical axis represents the probability. This diagram shows, in addition to the graphs of Recall and Precision shown in FIG. 9, a graph of Recall with respect to night scenes, which is drawn by a dotted line. When looking at this graph drawn by the dotted line, it is found that when the value of the discriminant equation with respect to landscapes is larger than −0.45, the probability that the image to be identified is a night scene image is 2.5%. In other words, even when the image to be identified is identified as not being a night scene image while the value of the discriminant equation with respect to landscapes is larger than −0.45, the probability of misidentification is no more than 2.5%. Here, the second negative threshold is therefore set to −0.45.

When the value of the discriminant equation is smaller than the first negative threshold or when the value of the discriminant equation is larger than the second negative threshold (“YES” in S206), the sub-identifying section 51 determines that the image to be identified does not belong to a predetermined scene, and sets a negative flag (S207). “Set a negative flag” refers to setting a “negative” field in FIG. 8 to 1. For example, when it is determined that the image to be identified does not belong to landscape scenes based on the first negative threshold, the “negative” field under the “landscape” column is set to 1. Moreover, when it is determined that the image to be identified does not belong to night scenes based on the second negative threshold, the “negative” field under the “night scene” column is set to 1.

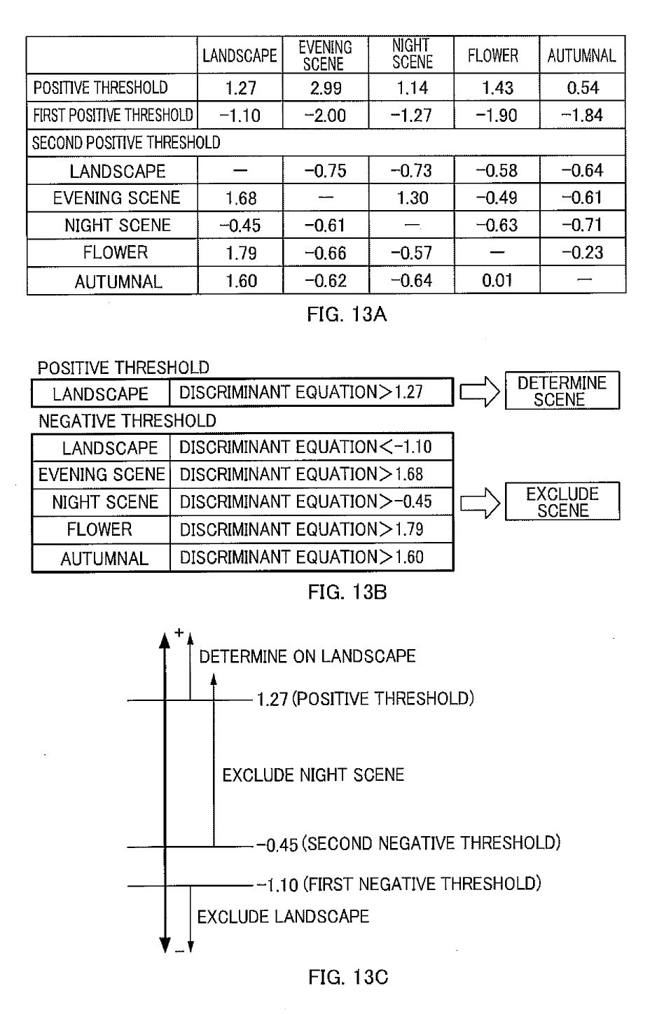

FIG. 13A is an explanatory diagram of a threshold table. This threshold table may be stored on the storing section 31 or may be incorporated into a part of a program for executing the overall identification processing. The threshold table has stored therein, data related to the above-mentioned positive threshold and negative threshold.

FIG. 13B is an explanatory diagram of the thresholds in the landscape identifying section 51L described above. In the landscape identifying section 51L, a positive threshold and a negative threshold are set in advance. The positive threshold is set to 1.27. The negative threshold includes a first negative threshold and second negative thresholds. The first negative threshold is set to −1.10. The second negative thresholds are set for scenes other than landscapes to respective values.

FIG. 13C is an explanatory diagram of an outline of the processing by the landscape identifying section 51L described above. Here, for the sake of simplicity of description, the second negative thresholds are described with respect to night scenes alone. When the value of the discriminant equation is larger than 1.27 (“YES” in S204), the landscape identifying section 51L determines that the image to be identified belongs to landscape scenes. When the value of the discriminant equation is not larger than 1.27 (“NO” in S204) and larger than −0.45 (“YES” in S206), the landscape identifying section 51L determines that the image to be identified does not belong to night scenes. When the value of the discriminant equation is smaller than −1.10 (“YES” in S206), the landscape identifying section 51L determines that the image to be identified does not belong to landscape scenes. It should be noted that the landscape identifying section 51L also determines with respect to evening scene, flower and autumnal scenes whether the image to be identified does not belong to these scenes based on the second negative thresholds. However, since the second negative threshold with respect to evening scene, flower and autumnal scenes are larger than the positive threshold, it is not possible for the landscape identifying section 51L to determine that the image to be identified does not belong to the evening scene, flower and autumnal scenes.

When it is “NO” in S202, when it is “NO” in S206, or when the process of S207 is finished, the overall identifying section 50 determines whether or not there is a subsequent sub-identifying section 51 (S208). Here, the processing by the landscape identifying section 51L has been finished, so that the overall identifying section 50 determines in S208 that there is a subsequent sub-identifying section 51 (evening scene identifying section 51S).

Then when the process of S205 is finished (when it is determined that the image to be identified belongs to a specific scene) or when it is determined in S208 that there is no subsequent sub-identifying section 51 (when it cannot be determined that the image to be identified belongs to a specific scene), the overall identifying section 50 terminates the overall identification processing.

As already described above, when the overall identification processing is terminated, the scene identification section 33 determines whether or not scene identification can be accomplished by the overall identification processing (S104 in FIG. 5). At this time, the scene identification section 33 references the identification target table shown in FIG. 8 and determines whether or not there is 1 in the “positive” field.

When scene identification can be accomplished by the overall identification processing (“YES” in S104), the partial identification processing and the integrative identification processing are omitted. Thus, the speed of the scene identification processing is increased.

Although it is not described above, when the overall identifying section 50 calculates a value with the discriminant equation by the sub-identifying section 51, the Precision corresponding to the value obtained with the discriminant equation as information relating to the certainty factor is stored in the result storing section 31B. It is a matter of course that the value of the discriminant equation itself may be stored as information relating to the certainty factor.

Partial Identification Processing

FIG. 14 is a flow diagram of the partial identification processing. The partial identification processing is performed when scene identification cannot be accomplished by the overall identification processing (“NO” in S104 in FIG. 5). As described in the following, the partial identification processing is processing for identifying the scene of the entire image by individually identifying the scenes of partial images into which the image to be identified is divided. Here, the partial identification processing is described also with reference to FIG. 6.

First, the partial identifying section 60 selects one sub-partial identifying section 61 from a plurality of sub-partial identifying sections 61 (S301). The partial identifying section 60 is provided with three sub-partial identifying sections 61. Each of the sub-partial identifying sections 61 identifies whether or not the 8×8=64 blocks of partial images into which the image to be identified is divided belong to a specific scene. The three sub-partial identifying sections 61 here identify evening scenes, flower scenes, and autumnal scenes, respectively. Here, the partial identifying section 60 selects the sub-partial identifying sections 61 in the order of evening scene→flower→autumnal (note that description on the order in which the sub-identifying sections 61 are selected will is provided later). Thus, at the start, the sub-partial identifying section 61 (evening scene partial identifying section 61S) for identifying whether or not the partial images belong to evening scenes is selected.

Next, the partial identifying section 60 references the identification target table (FIG. 8) and determines whether or not scene identification is to be performed using the selected sub-partial identifying section 61 (S302). Here, the partial identifying section 60 references the “negative” field under the “evening scene” column in the identification target table, and determines “YES” when there is zero and “NO” when there is 1. It should be noted that when, during the overall identification processing, the evening scene identifying section 51S sets a negative flag based on the first negative threshold or another sub-identifying section 51 sets a negative flag based on the second negative threshold, it is determined “NO” in this step S302. If it is determined “NO”, the partial identification processing with respect to evening scenes is omitted, so that the speed of the partial identification processing is increased. However, for convenience of description, it is assumed that the determination result here is “YES.”

Next, the sub-partial identifying section 61 selects one partial image from the 8×8=64 blocks of partial images into which the image to be identified is divided (8303).

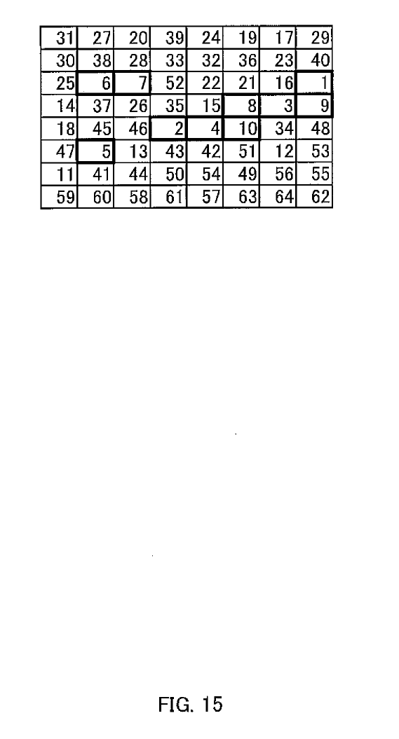

FIG. 15 is an explanatory diagram of the order in which the partial images are selected by the evening scene partial identifying section 61S. In a case where the scene of the entire image is identified based on partial images, it is preferable that the partial images used for identification are portions in which the subject is present. For this reason, several thousand sample evening scene images were prepared, each of the evening scene images was divided into 8×8=64 blocks, blocks containing a evening scene portion image (partial image of the sun and sky portion of a evening scene) were extracted, and based on the location of the extracted blocks, the probability that the evening scene portion image exists in each block was calculated. And partial images are selected in descending order of the existence probability of the blocks. It should be noted that information about the selection sequence shown in the diagram is stored in the memory 23 as a part of the program.

It should be noted that in the case of an evening scene image, the sky of the evening scene often extends from around the center portion to the upper half portion of the image, so that the existence probability increases in blocks located in a region from around the center portion to the upper half portion. In addition, in the case of an evening scene image, the lower ⅓ portion of the image often becomes dark due to backlight and it is impossible to determine based on a single partial image whether the image is an evening scene or a night scene, so that the existence probability decreases in blocks located in the lower ⅓ portion. In the case of a flower image, the flower is often positioned around the center portion of the image, so that the probability that a flower portion image exists around the center portion increases.

Next, the sub-partial identifying section 61 determines, based on the partial characteristic amounts of a partial image that has been selected, whether or not the selected partial image belongs to a specific scene (S304). The sub-partial identifying sections 61 employ a discrimination method using a support vector machine (SVM), as is the case with the sub-identifying sections 51 of the overall identifying section 50. A description of the support vector machine is provided later. When the value of the discriminant equation is a positive value, it is determined that the partial image belongs to the specific scene, and the sub-partial identifying section 61 increments a positive count value. When the value of the discriminant equation is a negative value, it is determined that the partial image does not belong to the specific scene, and the sub-partial identifying section 61 increments a negative count value.

Next, the sub-partial identifying section 61 determines whether or not the positive count value is larger than the positive threshold (S305). The positive count value indicates the number of partial images that have been determined to belong to the specific scene. When the positive count value is larger than the positive threshold (“YES” in S305), the sub-partial identifying section 61 determines that the image to be identified belongs to the specific scene, and sets a positive flag (S306). In this case, the partial identifying section 60 terminates the partial identification processing without performing identification by the subsequent sub-partial identifying sections 61. For example, when the image to be identified can be identified as an evening scene image, the partial identifying section 60 terminates the partial identification processing without performing identification with respect to flower and autumnal. In this case, the speed of the partial identification processing can be increased because identification by the subsequent sub-identifying sections 61 is omitted.

When the positive count value is not larger than the positive threshold (“NO” in S305), the sub-partial identifying section 61 cannot determine that the image to be identified belongs to the specific scene, and performs the process of the subsequent step S307.

When the sum of the positive count value and the number of remaining partial images is smaller than the positive threshold (“YES” in S307), the sub-partial identifying section 61 proceeds to the process of S309. When the sum of the positive count value and the number of remaining partial images is smaller than the positive threshold, it is impossible for the positive count value to be larger than the positive threshold even when the positive count value is incremented by all of the remaining partial images, so that identification using the support vector machine with respect to the remaining partial images is omitted by advancing the process to S309. As a result, the speed of the partial identification processing can be increased.

When the sub-partial identifying section 61 determines “NO” in S307, the sub-partial identifying section 61 determines whether or not there is a subsequent partial image (S308). Here, not all of the 64 partial images into which the image to be identified is divided are selected sequentially. Only the top-ten partial images outlined by bold lines in FIG. 15 are selected sequentially. For this reason, when identification of the tenth partial image is finished, the sub-partial identifying section 61 determines in S308 that there is no subsequent partial image. (With consideration given to this point, “the number of remaining partial images” is also determined.)

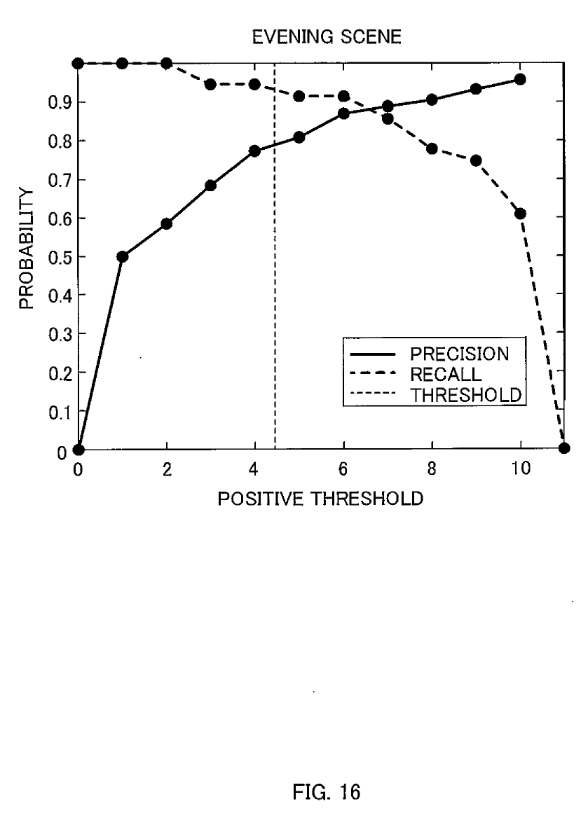

FIG. 16 shows graphs of Recall and Precision at the time when identification of an evening scene image was performed based on only the top-ten partial images. When the positive threshold is set as shown in this diagram, the precision ratio (Precision) can be set to about 80% and the recall ratio (Recall) can be set to about 90%, so that identification can be performed with high precision.

In partial identification processing, identification of the evening scene image is performed based on only ten partial images. Accordingly, the speed of the partial identification processing can be higher than in the case of performing identification of the evening scene image using all of the 64 partial images.

Moreover, in partial identification processing, identification of the evening scene image is performed using the top-ten partial images with high existence probabilities of an evening scene portion image. Accordingly, both Recall and Precision can be set to higher levels than in the case of performing identification of the evening scene image using ten partial images that have been extracted regardless of the existence probability.

Furthermore, in partial identification processing, partial images are selected in descending order of the existence probability of an evening scene portion image. As a result, it is more likely to be determined “YES” at an early stage in S305. Accordingly, the speed of the partial identification processing can be higher than in the case of selecting partial images in the order regardless of the degree of the existence probability.

When it is determined “YES” in S307 or when it is determined in S308 that there is no subsequent partial image, the sub-partial identifying section 61 determines whether or not the negative count value is larger than a negative threshold (S309). This negative threshold has almost the same function as the negative threshold (S206 in FIG. 7) in the above-described overall identification processing, and thus a detailed description thereof is omitted. When it is determined “YES” in S309, a negative flag is set as in the case of S207 in FIG. 7.

When it is “NO” in S302, when it is “NO” in S309, or when the process of S310 is finished, the partial identifying section 60 determines whether or not there is a subsequent sub-partial identifying section 61 (S311). When the processing by the evening scene partial identifying section 61S has been finished, there are remaining sub-partial identifying sections 61, i.e., the flower partial identifying section 61F and the autumnal partial identifying section 61R, so that the partial identifying section 60 determines in S311 that there is a subsequent sub-partial identifying section 61.

Then, when the process of S306 is finished (when it is determined that the image to be identified belongs to a specific scene) or when it is determined in S311 that there is no subsequent sub-partial identifying section 61 (when it cannot be determined that the image to be identified belongs to a specific scene), the partial identifying section 60 terminates the partial identification processing.

As already described above, when the partial identification processing is terminated, the scene identification section 33 determines whether or not scene identification can be accomplished by the partial identification processing (S106 in FIG. 5). At this time, the scene identification section 33 references the identification target table shown in FIG. 8 and determines whether or not there is 1 in the “positive” field.

When scene identification can be accomplished by the partial identification processing (“YES” in S106), the integrative identification processing is omitted. As a result, the speed of the scene identification processing is increased.

In the description given above, the evening scene partial identifying section 61S identifies evening scene images with the use of ten partial images. However, the number of partial images used for identifying is not limited to ten. Moreover, other sub-partial identifying sections 61 may identify images with the use of a number of partial images different from those of the evening scene partial identifying section 61S. Here, the flower partial identifying section 61F uses 20 partial images to identify flower images and the autumnal partial identifying section 61R uses 15 partial images to identify autumnal images.

Support Vector Machine

Before describing the integrative identification processing, the support vector machine (SVM) used by the sub-identifying sections 51 in the overall identification processing and the sub-partial identifying sections 61 in the partial identification processing is described.

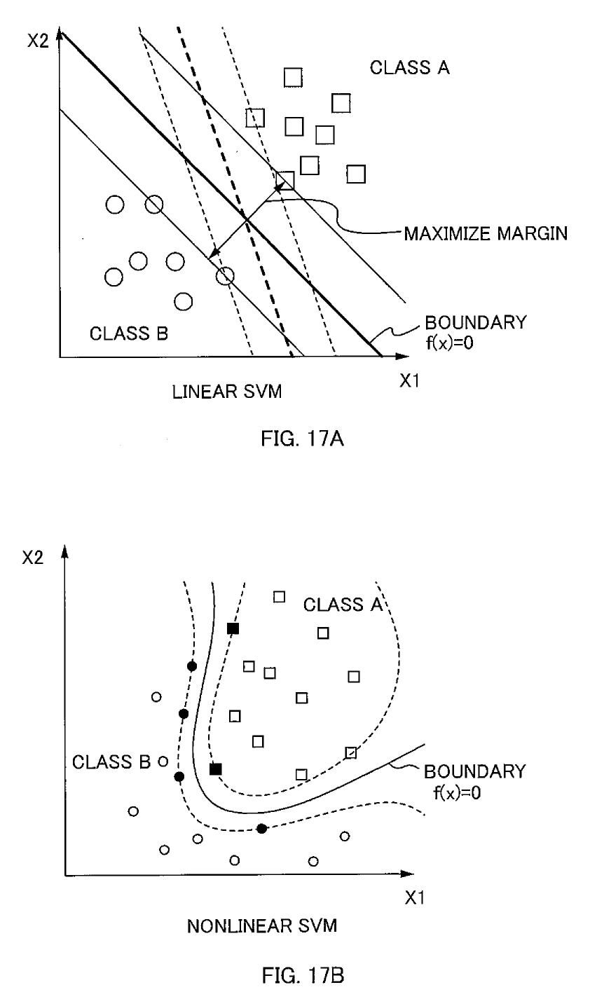

FIG. 17A is an explanatory diagram of discrimination by a linear support vector machine. Here, learning samples are shown in a two-dimensional space defined by two characteristic amounts x1 and x2. The learning samples are divided into two classes A and B. In the diagram, the samples belonging to the class A are represented by circles, and the samples belonging to the class B are represented by squares.

As a result of learning using the learning samples, a boundary that divides the two-dimensional space into two portions is defined. The boundary is defined as <w·x>+b=0 (where x=(x1, x2), w represents a weight vector, and <w·x> represents an inner product of w and x). However, the boundary is defined as a result of learning using the learning samples so as to maximize the margin. That is to say, in this diagram, the boundary is not the bold dotted line but the bold solid line.

Discrimination is performed using a discriminant equation f(x)=<w·x>+b. When a certain input x (this input x is separate from the learning samples) satisfies f(x)>0, it is determined that the input x belongs to the class A, and when f(x)<0, it is determined that the input x belongs to the class B.

Here, discrimination is described using the two-dimensional space. However, this is not intended to be limiting (i.e., more than two characteristic amounts maybe used) In this case, the boundary is defined as a hyperplane.

There are cases where separation between the two classes cannot be achieved by using a linear function. In such cases, when discrimination with a linear support vector machine is performed, the precision of the discrimination result decreases. To address this problem, the characteristic amounts in the input space are nonlinearly transformed, or in other words, nonlinearly mapped from the input space into a certain feature space, and thus separation in the feature space can be achieved by using a linear function. A nonlinear support vector machine uses this method.

FIG. 17B is an explanatory diagram of discrimination using a kernel function. Here, learning samples are shown in a two-dimensional space defined by two characteristic amounts x1 and x2. When a nonlinear mapping from the input space shown in FIG. 17B is a feature space as shown in FIG. 17A, separation between the two classes can be achieved by using a linear function. When a boundary is defined so as to maximize the margin in this feature space, an inverse mapping of the boundary in the feature space is the boundary shown in FIG. 17B. As a result, the boundary is nonlinear as shown in FIG. 17B.

Since the Gaussian kernel is used here, the discriminant equation f(x) is expressed by the following formula:

$$f ( x ) = {\sum }_{i}^{N} {w}_{i} exp ( - {\sum }_{j}^{M} \frac{{( {x}_{j} - {y}_{j} )}^{2}}{2 {σ}^{2}} ) \qquad Formula 1$$

where M represents the number of characteristic amounts, N represents the number of learning samples (or the number of learning samples that contribute to the boundary), wᵢ represents a weight factor, yⱼ represents the characteristic amount of the learning samples, and xⱼ represents the characteristic amount of an input x.

When a certain input x (this input x is separate from the learning samples) satisfies f(x)>0, it is determined that the input x belongs to the class A, and when f(x)<0, it is determined that the input x belongs to the class B. Moreover, the larger the value of the discriminant equation f(x) is, the higher the probability that the input x (this input x is separate from the learning samples) belongs to the class A is. Conversely, the smaller the value of the discriminant equation f(x) is, the lower the probability that the input x (this input x is separate from the learning samples) belongs to the class A is.

The sub-identifying sections 51 in the overall identification processing and the sub-partial identifying sections 61 in the partial identification processing, which are described above, employ the value of the discriminant equation f(x) of the above-described support vector machine. The time required to calculate the value of the discriminant equation f(x) by the support vector machine increases when the learning samples grow in number. Therefore, the sub-partial identifying sections 61 that need to calculate the value of the discriminant equation f(x) a plurality of times require more processing time compared to the sub-identifying sections 51 that need to calculate the value of the discriminant equation f(x) only once.

It should be noted that evaluation samples are prepared separately from the learning samples. The above-described graphs of Recall and Precision are based on the identification result with respect to the evaluation samples.

Integrative Identification Processing

In the above-described overall identification processing and partial identification processing, the positive threshold in the sub-identifying sections 51 and the sub-partial identifying sections 61 is set to a relatively high value to set Precision (accuracy rate) to a rather high level. The reason for this is that when, for example, the accuracy rate of the landscape identifying section 51L of the overall identification section is set to a low level, a problem occurs in that the landscape identifying section 51L misidentifies an autumnal image as a landscape image and terminates the overall identification processing before identification by the autumnal identifying section 51R is performed. Here, Precision (accuracy rate) is set to a rather high level, and thus an image belonging to a specific scene is identified by the sub-identifying section 51 (or the sub-partial identifying section 61) with respect to that specific scene (for example, an autumnal image is identified by the autumnal identifying section 51R (or the autumnal partial identifying section 61R)).

However, when Precision (accuracy rate) of the overall identification processing and the partial identification processing is set to a rather high level, the possibility that scene identification cannot be accomplished by the overall identification processing and the partial identification processing increases. To address this problem, when scene identification could not be accomplished by the overall identification processing and the partial identification processing, the integrative identification processing described in the following is performed.

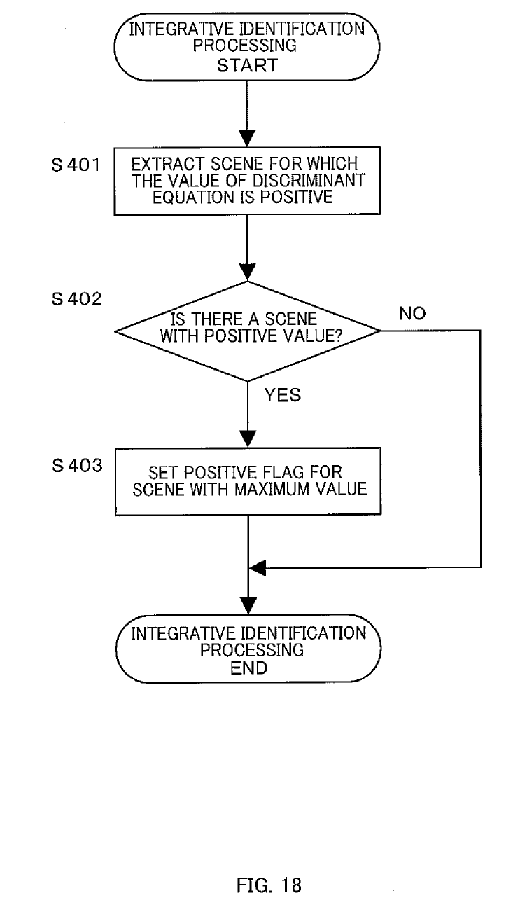

FIG. 18 is a flow diagram of the integrative identification processing. As described in the following, the integrative identification processing is processing for selecting a scene with the highest certainty factor based on the value of the discriminant equation of each sub-identifying section 51 in the overall identification processing.

First, the integrative identifying section 70 extracts, based on the values of the discriminant equations of the five sub-identifying sections 51, a scene for which the value of the discriminant equation is positive (S401). At this time, the value of the discriminant equation calculated by each of the sub-identifying sections 51 during the overall identification processing is used.

Next, the integrative identifying section 70 determines whether or not there is a scene for which the value of the discriminant equation is positive (S402).

When there is a scene for which the value of the discriminant equation is positive (“YES” in S402), a positive flag is set under the column of a scene with the maximum value (S403), and the integrative identification processing is terminated. Thus, it is determined that the image to be identified belongs to the scene with the maximum value.

On the other hand, when there is no scene for which the value of the discriminant equation is positive (“NO” in S402), the integrative identification processing is terminated without setting a positive flag. Thus, there is still no scene for which 1 is set in the “positive” field of the identification target table shown in FIG. 8. That is to say, which scene the image to be identified belongs to could not be identified.

As already described above, when the integrative identification processing is terminated, the scene identification section 33 determines whether or not scene identification can be accomplished by the integrative identification processing (S108 in FIG. 5). At this time, the scene identification section 33 references the identification target table shown in FIG. 8 and determines whether or not there is 1 in the “positive” field. When it is determined “NO” in S402, it is also determined “NO” in S108.

### First Embodiment

Overall Description

The preferences of users vary among individuals, and therefore while some people may prefer to identify a certain image as “landscape”, others may prefer to not identify that image as “landscape”. Accordingly, in the present embodiment, the preferences of a user are enabled to be reflected in the identification processing.

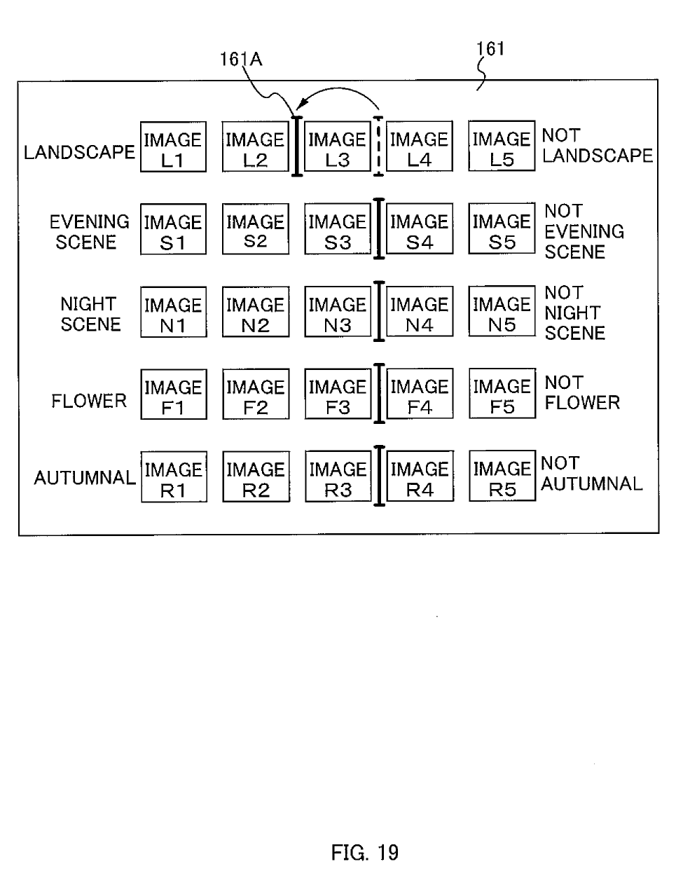

FIG. 19 is an explanatory diagram of a settings screen according to the first embodiment. A settings screen 161 is a screen that is displayed on a display section 16 of the printer 4. Five images respectively for each of the corresponding scenes are displayed on the settings screen 161. All of these images are images of learning samples of a support vector machine (SVM). Here, description is given regarding five images L1 to L5 displayed on the topmost row corresponding to “landscape”.

The five images L1 to L5 are displayed so that images further to the right among these five images are images that are less related to landscapes (discussed later). Then, in an initial setting, the learning samples corresponding to the three images L1 to L3 are set so as to belong to landscape and the learning samples corresponding to the two images L4 and L5 are set so as to not belong to landscape. In accordance with this, initially in the display of the settings screen 161, a border setting bar 161A is displayed between the image L3 and the image L4 so as to indicate a border between the images belonging to landscape and the images not belonging to landscape.

The positioning of the border setting bar 161A can be changed by the user. For example, in a case where the user has judged that the image L3 displayed on the display section 16 is not a landscape image, the user operates a panel section 17 to select the border setting bar 161A corresponding to landscape among the five border setting bars 161A, then moves that border setting bar 161A one place to the left so as to be between the image L2 and the image L3.

Then, the processing in the sub-identifying section 51 is changed in response to the position of the border setting bar 161A that has been set (discussed later). As a result, when the landscape identifying section 51L identifies an image similar to the image L3, the landscape identifying section 51L is enabled to identify it as not belonging to a scene of a landscape even though it would have been identified as belonging to a scene of a landscape if the initial settings were left as they were. In other words, the preference of the user is reflected in the identification processing.

Below, description is given first regarding data stored in the memory 23 of the printer 4. After this, description is given regarding a manner in which the settings screen 161 is displayed. And after this, description is given regarding how the processing of the sub-identifying section 51 is changed after a border has been set on the settings screen 161.

Data of Learning Samples Stored in Memory

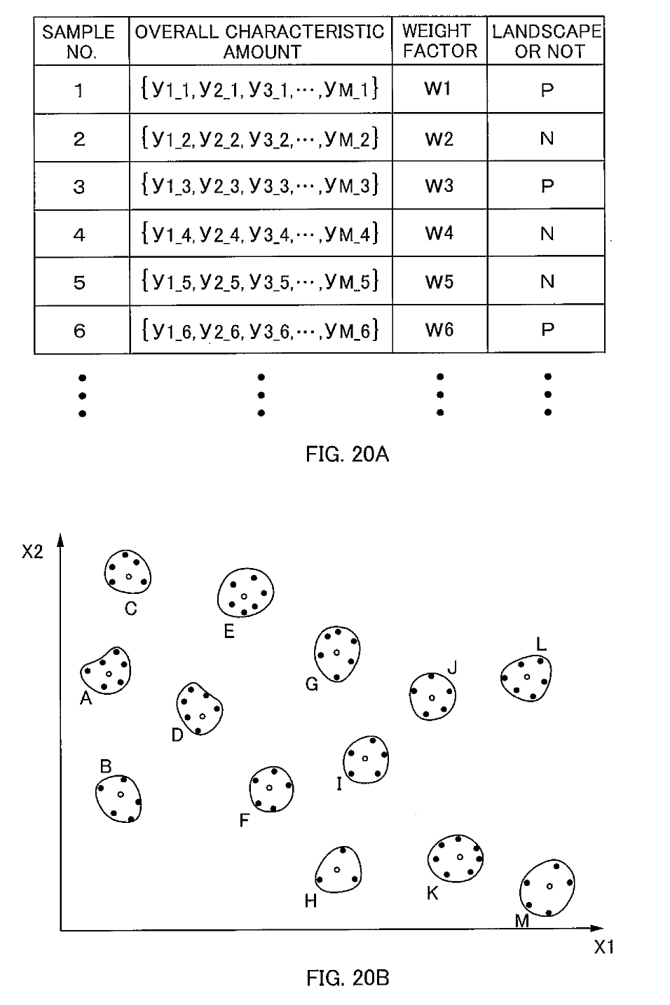

First, description is given regarding data stored in the memory 23 of the printer 4. As described below, the memory 23 stores data groups shown in FIG. 20A and image data of learning samples indicated by white dots in FIG. 20B.

FIG. 20A shows data groups of learning samples stored in the memory 23. Here, the data groups used in the support vector machine of the landscape identifying section 51L are shown.

As shown in the diagram, it is not the actual information of the image (image data) of the learning sample that is stored, but rather the overall characteristic amounts of the learning samples are stored in the memory 23. Furthermore, the weight factors w associated with each of the learning samples are also stored in the memory 23. The weight factor w can be calculated using the data group of the overall characteristic amount of the learning sample, but here the weight factors w are calculated in advance and stored in the memory 23. The value of the above-described discriminant equation f(x) is calculated based on the equation of the above-described Formula 1 using an overall characteristic amount y of the data group and a weight factor w. It should be noted that the weight factors of the learning samples that do not contribute to determining the border become zero, and therefore ordinarily it is not necessary to store the overall characteristic amounts of those learning samples in the memory 23, but in the present embodiment the overall characteristic amounts of all the learning samples are stored in the memory 23.

Further still, in the present embodiment, information (attribute information) indicating whether or not it belongs to a landscape scene is associated with each of the learning samples and stored. “P” is set as the attribute information for images belonging to a landscape scene and “N” is set as the attribute information for images not belonging to a landscape scene. As is described later, the attribute information is used in displaying the settings screen 161 of FIG. 19 and is changed in response to the setting of the border setting bar 161A of FIG. 19.

FIG. 20B is an explanatory diagram of a distribution of learning samples. In order to simplify the description here, the learning samples are distributed in a two-dimensional space according to two characteristic amounts. Each of the dots respectively indicates a position of the learning samples in the two-dimensional space.

The learning samples have undergone clustering in advance and in FIG. 20B clustering has been implemented for 13 clusters (cluster A to cluster M). Here, clustering is performed using a commonly known k-means method. A clustering technique based on the k-means method is as follows. (1) First, a computer provisionally determines a center position of a cluster. Here, the 13 center positions are provisionally determined randomly. (2) Next, the computer sorts the learning samples into the cluster having the nearest center. In this manner, new clusters are determined. (3) Next, the computer calculates mean values of the characteristic amounts of the learning samples of each cluster, then sets the mean value as the new center position of the cluster. (4) Clustering finishes if the new center position of the cluster has not changed from the previous center position of the cluster, but if it has changed, the procedure returns to (2).

It should be noted that this results in learning samples having similar properties belong to the same cluster. For example, the cluster A may be configured by learning samples of blue sky images and the cluster B may be configured by learning samples of verdure images.

The white dots in FIG. 20B indicate the position of the learning sample that is nearest to the center position of each cluster. The white dot learning samples are samples that represent the clusters (representative samples). Image data of the representative samples indicated by white dots are stored in the memory 23. In other words, image data of images that represent each cluster are stored in the memory 23. As is described later, this representative image data is used in displaying the settings screen 161 of FIG. 19.

As described above, the memory 23 of the printer 4 stores the data groups shown in FIG. 20A and image data of representative samples indicated by white dots in FIG. 203. It should be noted that data indicating the cluster to which each learning sample belongs may be or may not be stored in the memory 23. This is because data indicating the cluster to which each learning sample belongs can be obtained using the data groups of FIG. 20A.

Processing Until Display of the Settings Screen 161

Next, description is given regarding a manner in which the settings screen 161 of FIG. 19 is displayed by the printer-side controller 20.

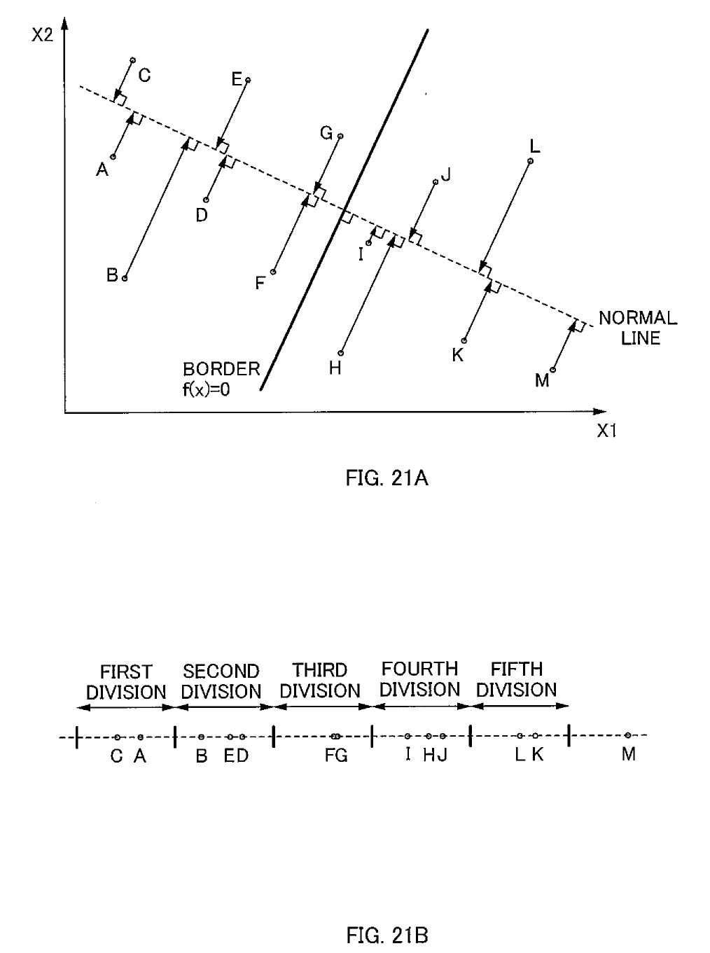

FIG. 21A is an explanatory diagram of how a representative sample is projected onto a normal line of a border (f(x)=0). Here again, in order to simplify the description, the representative samples are distributed in a two-dimensional space. Also, to simplify the description, the two-dimensional space is a space that can be separated using a linear function as shown in FIG. 17A. Thus, a border (f(x)=0) separating the landscape image samples and non-landscape image samples is defined by a straight line. (It should be noted that in the default settings, learning samples belonging to the clusters A to G are landscape images and the learning samples belonging to the clusters H to M are non-landscape images.)

In the diagram, the positions of the representative samples in the two-dimensional space are indicated by white dots, and the border (f(x)=0) is indicated by a bold line. It should be noted that the border is a default border prior to the changing of the settings.

The printer-side controller 20 defines a single normal line in relation to the border and projects the representative sample onto the normal line. The projected positions are intersection points between straight lines passing through the representative samples and parallel to the boundary (or a hyperplane if the border is a hyperplane), and the normal line. Thirteen representative samples are projected onto the normal line in this manner. In other words, 13 representative samples are arranged on a single straight line.

FIG. 21B is an explanatory diagram of representative samples that have been projected onto a normal line. The normal line is made horizontal to show the positional relationships of the representative samples that have been projected onto the normal line so that the landscape image representative samples are positioned on the left side of the diagram or, in other words, so that the non-landscape image representative samples are positioned on the right side of the diagram.

Next, the printer-side controller 20 defines five divisions on the normal line. A first division to a fifth division are defined in the diagram. Each division is defined so as to have a predetermined length. And the five divisions are defined so that the position of the intersection point between the normal line and the border (f(x)=0) in FIG. 21A is on the border of two divisions. Here, the position of the intersection point between the normal line and the border (f(x)=0) in FIG. 21A corresponds to the boundary between the third division and the fourth division. It should be noted that a plurality of representative samples are present in each division.

Next, the printer-side controller 20 extracts image data of the representative samples positioned in a center of each division. Here, image data of the representative sample of the cluster C is extracted from the first division. Similarly, image data of the representative samples of the clusters E, F, H, and L are extracted from the second, third, fourth, and fifth divisions respectively. At this time, representative samples that are set in the default settings as belonging to a landscape scene are extracted from the first to third divisions. And representative samples that are set in the default settings as not belonging to a landscape scene are extracted from the fourth and fifth divisions. The extracted image data can be considered as representatives of each division.

The printer-side controller 20 uses the extracted image data and displays the settings screen 161 on the display section 16 of the printer 4. The image data of the representative sample of the cluster C that has been extracted from the first division is used in displaying the image L1 of FIG. 19. Similarly, image data of the representative samples of the clusters E, F, H, and L are used in displaying the images L2, L3, L4, and L5 of FIG. 19 respectively.

Furthermore, since the position of an intersection point between the normal line and the border (f(x)=0) in FIG. 21A corresponds to the boundary between the third division and the fourth division, the printer-side controller 20 displays the border setting bar 161A between the image L3 (the image of the representative sample extracted from the third division) and the image L4 (the image of the representative sample extracted from the fourth division) in FIG. 19. In this regard, since the images L1 to L3 are landscape images and the images L4 and L5 are non-landscape images, the border setting bar 161A is displayed between the landscape images and the non-landscape images.

As described above, in the present embodiment the position of the representative samples are projected onto a normal line of the border and the representative samples to be extracted are determined based on the positions of the representative samples projected onto the normal line. In this way, in the present embodiment, the five images of the representative samples are displayed so that images having larger values of the discriminant equation are lined further to the left. In other words, the five images of the representative samples can be displayed so that they are lined from the left in order of higher certainty factors for belonging to a landscape scene.

And since the settings screen 161 of FIG. 19 is displayed as described above, the representative samples of landscape images are displayed on the left side of the border setting bar 161A under the default settings. Furthermore, the representative samples of non-landscape images are displayed on the right side of the border setting bar 161A under the default settings. And the five images L1 to L5 are displayed so that among these five images, images further to the right are images that are less related to a landscape. Furthermore, images that are displayed near the border setting bar 161A are images for which judgment of whether or not they are a landscape image tends to vary according to the preference of the user.

In the above description, description was given regarding landscape scenes, but the printer-side controller 20 carries out equivalent processing for the other scenes as well. In this way, the printer-side controller 20 can also display portions other than landscapes of the settings screen 161 in FIG. 19.

Processing After the Border has Been Set at the Settings Screen 161

Next, description is given regarding processing after the user moves the border setting bar 161A one place to the left and sets it between the image L2 and the image L3 as shown in FIG. 19.

After the border setting bar 161A is moved, the image L3 (which is the representative sample image of the cluster F and an image that represents the third division), which is a landscape image under the default settings, becomes positioned on the right side of the border setting bar 161A between the border setting bar 161A and the image L4, which is a non-landscape image under the default settings. Since the user has moved the border setting bar 161A from between the image L3 and the image L4 to between the image L2 and the image L3, it can be assumed that the user thinks that the learning samples belonging to the clusters F and G, which belong to the third division shown in FIG. 21B, are not landscape images but rather non-landscape images.

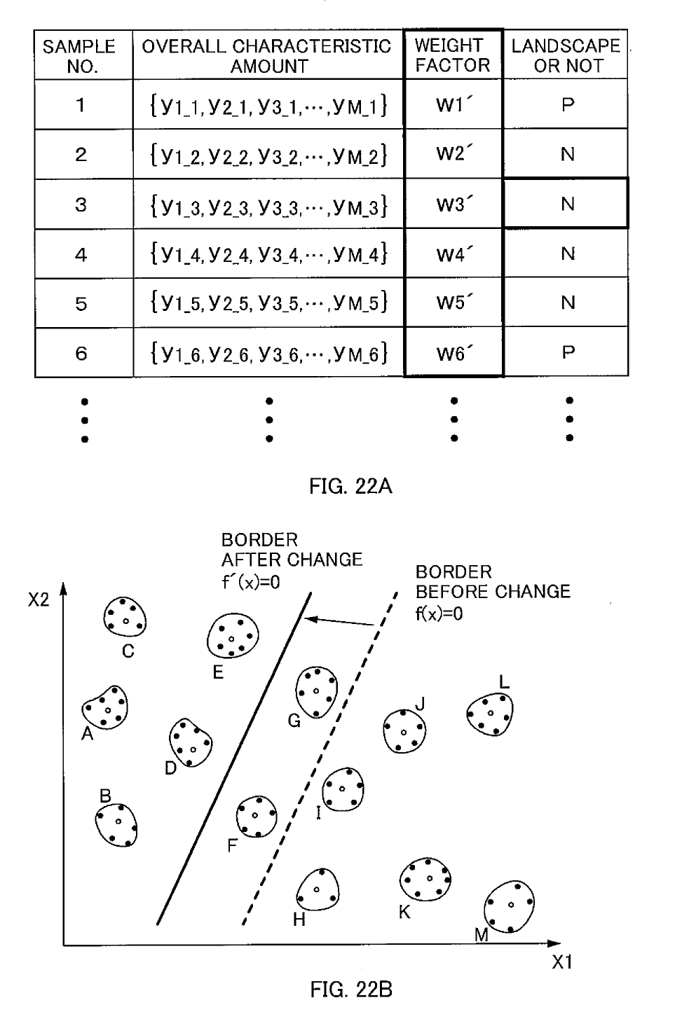

FIG. 22A is an explanatory diagram of a data group after being changed. FIG. 22B is an explanatory diagram of a border after being changed. Description is given below using these diagrams regarding the processing of the printer-side controller 20 after the settings changes.

First, the printer-side controller 20 changes from P to N the attribute information of the learning samples belonging to the clusters F and G. For example, say the sample number 3 in FIG. 20A belongs to the cluster F or cluster G, then the attribute information is changed from P to N as shown in FIG. 22A.

In the present embodiment, not only is the attribute information of the representative sample of the cluster F changed, but the attribute information of all the learning samples belonging to the cluster F are changed. In this way, the attribute information of learning samples having similar properties to the image that the user wishes not to belong to landscape can be changed collectively by a single operation of the user.

Furthermore, in the present embodiment, not only is the attribute information of the representative sample of the cluster F changed, but the attribute information of all the learning samples belonging to the third division are changed. In this way, the attribute information of learning samples that are apart from the border to a similar extent as the image that the user wishes not to belong to landscape can be changed collectively by a single operation of the user.

Next, based on the overall characteristic amounts and the attribute information after changing, the printer-side controller 20 carries out relearning of the support vector machine and changes the border as shown in FIG. 22B. In other words, based on the overall characteristic amounts and the attribute information after changing, the printer-side controller 20 carries out relearning and changes the weight factors w of FIG. 20A as shown in FIG. 22A. Here, the border after changing is expressed as f′(x)=0 and the weight factor after changing is expressed as w′. It should be noted that the arithmetic processing of relearning is the same as that of an ordinary support vector machine, and therefore description of relearning is omitted.

The weight factor w (or w′) becomes zero if it does not contribute to determining the border. For this reason, weight factors w that were zero in FIG. 20A may sometimes have a value other than zero due to a change. Conversely, weight factors w that held a value other than zero in FIG. 20A may sometimes become zero due to a change. This is why even the data of learning samples that do not contribute to determining the border under the default settings are also stored in the data group of FIG. 20A.

When the landscape identifying section 51L determines whether or not an image to be identified belongs to a landscape scene, the landscape identifying section 51L calculates the value of the discriminant equation of the aforementioned Formula 1 (the value of the discriminant equation f′(x) after changing) based on the overall characteristic amounts of the learning samples of the data group of FIG. 22B and the weight factor w′ after changing. It should be noted that the landscape identifying section 51L calculates the value of the discriminant equation of the aforementioned Formula 1 excluding learning samples whose weight factors w′ are zero. In this way, the speed of calculation becomes faster than a case where the value of the discriminant equation is obtained using all the learning samples.

By using the discriminant equation f′(x) after changing, the identification processing reflecting the preferences of the user can be carried out. For example, say if the image L3 (see FIG. 19) is an image of a building and the image to be identified is an image of a building, it would be difficult to judge that the image to be identified belongs to a landscape scene. In other words, if the cluster F (see FIG. 22B) is constituted by learning samples of images of buildings and the image to be identified is an image of a building, then it would be difficult to judge that the image to be identified belongs to a landscape scene.

In the present embodiment, a settings change that matches the preferences of the user can be carried out easily. Suppose that images of learning samples are displayed one by one and the user has to determine one by one whether or not the image of the displayed learning sample is a landscape, then the user would have to carry out the determining operation numerous times, making it inconvenient.

It should be noted that in the foregoing description, description was given regarding a case where the user moved the border setting bar 161A one place to the left. In contrast to this, suppose that the user has moved the border setting bar 161A one place to the right, the image L4 (which is the representative sample image of the cluster H and an image that represents the fourth division), which is a non-landscape image under the default settings, becomes positioned on the left side of the border setting bar 161A between the border setting bar 161A and the image L3, which is a landscape image under the default settings. In a case such as this, the printer-side controller 20 changes from N to P the attribute information of the learning samples belonging to the clusters I, H, and J belonging to the fourth division, and carries out relearning of the support vector machine based on the overall characteristic amounts and the attribute information after changing, thereby changing the border. In this case also, the identification processing reflecting the preferences of the user can be carried out.

### MODIFIED EXAMPLE OF THE FIRST EMBODIMENT

In this modified example, the discriminant equation is changed and a positive threshold is also changed. Here also description is given regarding processing after the user moves the border setting bar 161A one place to the left and sets it between the image L2 and the image L3.

First, the printer-side controller 20 changes from P to N the attribute information of the learning samples belonging to the clusters F and G. The processing here is the same as that in the first embodiment, which has already been described.

Next, based on the overall characteristic amounts and the attribute information after changing, the printer-side controller 20 carries out relearning of the support vector machine and changes the border (changes the discriminant equation). The processing here is also the same as that in the first embodiment.

Next, the printer-side controller 20 uses evaluation samples (on condition that the attribute information of the evaluation samples are changed in response to the setting of the border setting bar 161A by the user) and generates a graph of Precision (see FIG. 9) of an identification result according to the discriminant equation f′(x) after changing. Then it specifies a positive threshold so that the regenerated Precision becomes 97.5%. In this way, the settings changes of the landscape identifying section 51L are finished.

When the landscape identifying section 51L determines whether or not an image to be identified belongs to a landscape scene, the landscape identifying section 51L calculates the value of the discriminant equation based on the overall characteristic amounts of the image to be identified. Then, if the value of the discriminant equation is greater than the positive threshold after changing (yes at S204 in FIG. 7), then the landscape identifying section 51L determines that the image to be identified belongs to a landscape scene and sets a positive flag (S205).

In a same manner as in the above-described first embodiment, with this modified example also, an identification processing reflecting the preferences of the user can be carried out.

### Second Embodiment

Overall Description

The preferences of users vary among individuals, and therefore while some people may prefer to identify a certain image as “landscape”, others may prefer to identify that image as “evening scene”. Accordingly, in a second embodiment, the preferences of a user are enabled to be reflected in the identification processing.

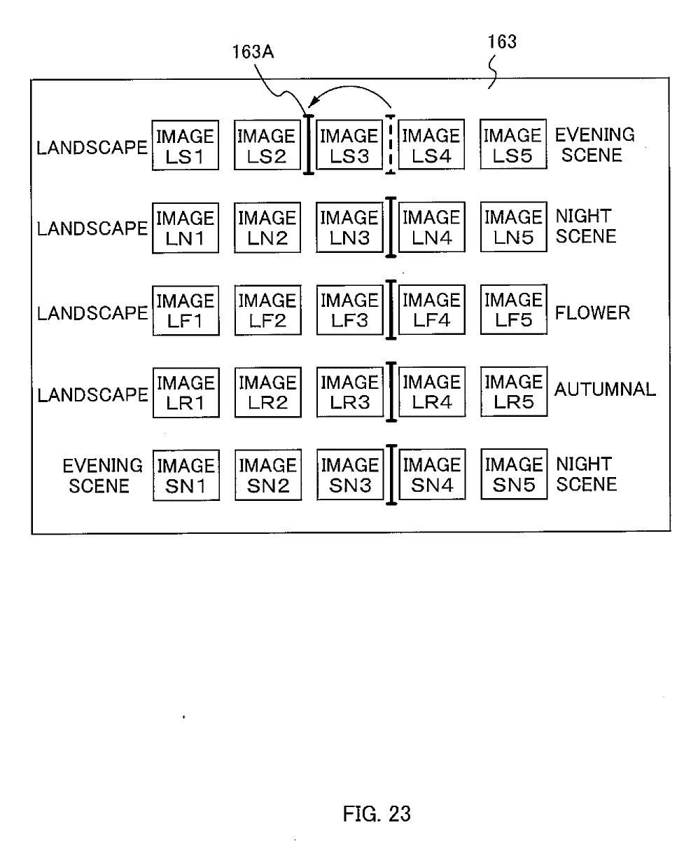

FIG. 23 is an explanatory diagram of a settings screen according to the second embodiment. A settings screen 163 is a screen that is displayed on a display section 16 of a printer 4. Five images respectively for each of the corresponding scenes are displayed on the settings screen 163. All of these images are images of learning samples of support vector machines (SVM). Here, description is given regarding five images LS1 to LS5 displayed on the topmost row corresponding to “landscape” and “evening scene”.

Of these five images, images further to the left are images in which characteristics of a landscape appear more strongly, and images further to the right are images in which characteristics of an evening scene appear more strongly. In other words, the five images LS1 to LS5 are displayed so that the five images transition from landscape images to evening scene images in order from left to right (discussed later). Then, under an initial setting, the learning samples corresponding to the three images LS1 to LS3 are set so as to belong to landscape and the learning samples corresponding to the two images LS4 and LS5 are set so as to belong to evening scene. In accordance with this, initially in the display of the settings screen 163, a border setting bar 163A is displayed between the image LS3 and the image LS4 so as to indicate a border between the images belonging to landscape and the images belonging to evening scene.

The positioning of the border setting bar 163A can be changed by the user. For example, in a case where the user has judged that the image LS3 displayed on the display section 16 is not a landscape image but an evening scene image, the user operates a panel section 15 to select the topmost row border setting bar 163A among the five border setting bars 163A, then moves that border setting bar 163A one place to the left so as to be between the image LS2 and the image LS3.

Then, the processing in the sub-identifying section 51 is changed in response to the position of the border setting bar 163A that has been set (discussed later). As a result, when the landscape identifying section 51L identifies an image similar to the image LS3, the landscape identifying section 51L is enabled to identify it as not belonging to a landscape scene even though it would have been identified as belonging to a landscape scene if the initial settings were left as they were. Furthermore, when the evening scene identifying section 51S identifies an image similar to the image LS3, the evening scene identifying section 51S is enabled to identify it as belonging to an evening scene even though it would have been identified as not belonging to an evening scene if the initial settings were left as they were. In other words, the preference of the user is reflected in the identification processing.

Below, description is given first regarding data stored in the memory 23 of the printer 4. After this, description is given regarding a manner in which the settings screen 163 is displayed. And after this, description is given regarding how the processing of the sub-identifying section 51 is changed after the border has been set on the settings screen 163.

Data of Learning Samples Stored in Memory

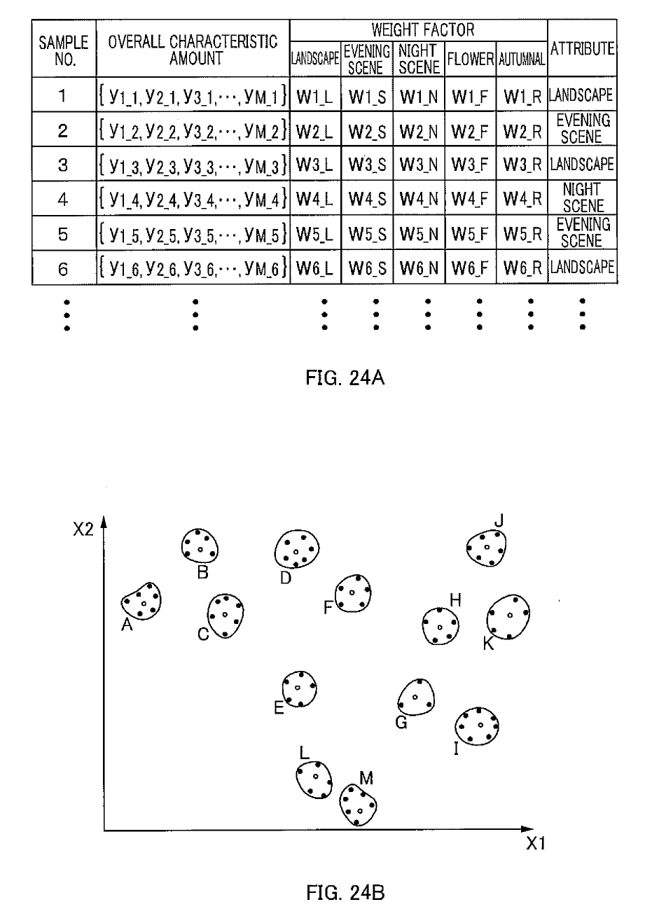

First, description is given regarding data stored in the memory 23 of the printer 4. As described below, data groups shown in FIG. 24A and image data of learning samples indicated by white dots in FIG. 24B are stored in the memory 23.

FIG. 24A shows data groups of learning samples stored in the memory 23. As shown in FIG. 24A, it is not the actual information of the images (image data) of the learning samples that is stored, but rather the overall characteristic amounts of the learning samples are stored in the memory 23. Furthermore, the weight factors w for each scene are associated with each of the learning samples and also stored in the memory 23. The weight factor w can be calculated using the data group of the overall characteristic amount of the learning sample, but here the weight factors w are calculated in advance and stored in the memory 23. The value of the above-described discriminant equation f(x) is calculated based on the equation of the above-described Formula 1 using an overall characteristic amount y of the data group and a weight factor w (for example, in the case of the discriminant equation f(x) of the landscape identifying section 51L, this is the weight factor having a suffix L). It should be noted that the weight factors of the learning samples that do not contribute to determining the border become zero, and therefore ordinarily it is not necessary to store the overall characteristic amounts of those learning samples in the memory 23, but in the present embodiment the overall characteristic amounts of all the learning samples are stored in the memory 23.

Further still, in the present embodiment, information (attribute information) indicating to which scene each of the learning samples belong to is associated with each of the learning samples and stored. As is described later, the attribute information is used in displaying the settings screen 163 of FIG. 23 and is changed in response to the setting of the border setting bar 163A of FIG. 23.

FIG. 24B is an explanatory diagram of a distribution of learning samples. In order to simplify description here, the learning samples are distributed in a two-dimensional space according to two characteristic amounts. Each of the dots respectively indicates a position of the learning samples in the two-dimensional space.

The learning samples have undergone clustering in advance and in FIG. 24B clustering has been implemented for 13 clusters (cluster A to cluster M). Here, clustering is performed using a commonly known k-means method. A clustering technique based on the k-means method is as follows. (1) First, a computer provisionally determines a center position of the cluster. Here, the 13 center positions are provisionally determined randomly. (2) Next, the computer sorts the learning samples into the cluster having the nearest center. In this manner, new clusters are determined. (3) Next, the computer calculates mean values of the characteristic amounts of the learning samples of each cluster, then sets the mean value as the new center position of the cluster. (4) Clustering finishes if the new center position of the cluster has not changed from the previous center position of the cluster, but if it has changed, the procedure returns to (2).

It should be noted that this results in learning samples having similar properties belong to the same cluster. For example, the cluster A may be configured by learning samples of blue sky images and the cluster B may be configured by learning samples of verdure images. It should be noted that in the default settings, learning samples belonging to the clusters A to F are landscape images and the learning samples belonging to the clusters G to K are evening scene images, while learning samples belonging to the clusters L and M are night scene images (learning samples for flower images and autumnal images are not shown in the diagram).

The white dots in FIG. 24B indicate the position of the learning sample that is nearest to the center position of each cluster. The white dot learning samples are samples that represent the clusters (representative samples). Image data of the representative samples indicated by white dots are stored in the memory 23. In other words, image data of images that represent each cluster are stored the memory 23. As is described later, this representative image data is used in displaying the settings screen 163 of FIG. 23.

As described above, the memory 23 of the printer 4 stores the data groups shown in FIG. 24A and image data of representative samples indicated by white dots in FIG. 24B. It should be noted that data indicating the cluster to which each learning sample belongs may be or may not be stored in the memory 23. This is because data indicating the cluster to which each learning sample belongs can be obtained using the data groups of FIG. 24A.

Processing Until Display of the Settings Screen 163

Next, description is given regarding a manner in which the settings screen 163 such as that shown in FIG. 23 is displayed by the printer-side controller 20. Here, description is given mainly regarding how the topmost five images LS1 to LS5 of the settings screen 163 are displayed.

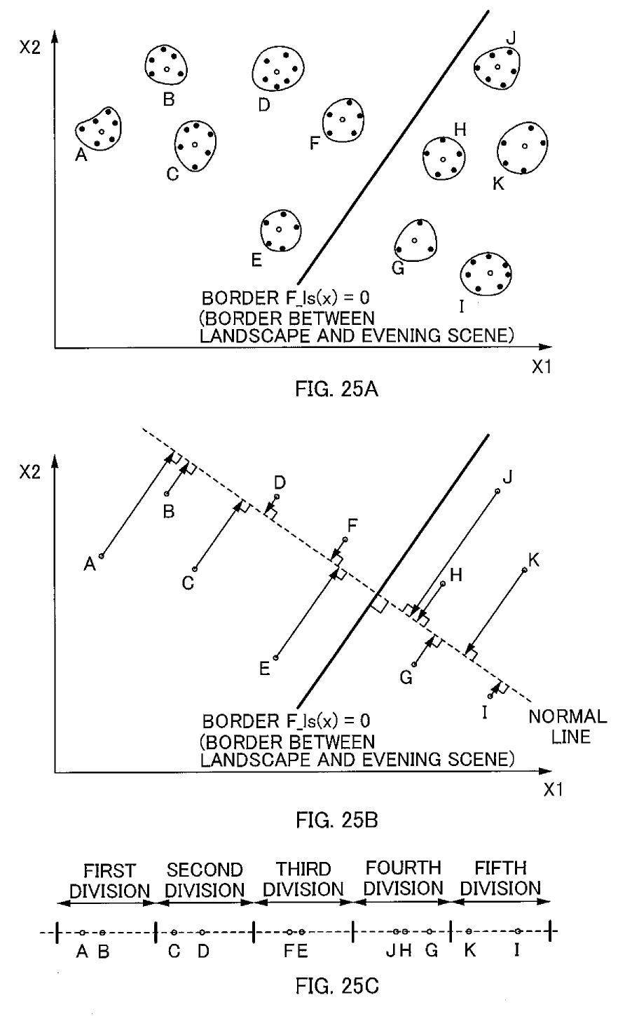

FIG. 25A is an explanatory diagram of a border F_ls(x)=0 that separates landscape images and evening scene images. In FIG. 25A, only the learning samples for landscapes and evening scenes are shown, and the learning samples for other scenes (night scene for example) are not shown. Also, to simplify description, the two-dimensional space is a space that can be separated using a linear function as shown in FIG. 17A. Thus, the border F_ls(x)=0 separating the landscape image samples and the evening scene image samples is defined as a straight line. The printer-side controller 20 obtains the border F_ls(x)=0 through learning using the learning samples of landscape and evening scenes. The arithmetic processing of this learning is the same as that of an ordinary support vector machine, and therefore description thereof is omitted.

FIG. 25B is an explanatory diagram of how a representative sample is projected onto a normal line of the border (F_ls(x) =0). In FIG. 25B, the positions of the representative samples in the two-dimensional space are indicated by the white dots. The printer-side controller 20 defines a single normal line for the border and projects the representative sample onto the normal line. The projected positions are intersection points between a straight line passing through the representative sample and parallel to the boundary (or a hyperplane if the border is a hyperplane), and the normal line. Eleven representative samples are projected onto the normal line in this manner. In other words, 11 representative samples are aligned in a single straight line. It should be noted that the representative samples projected onto the normal line are representative samples of landscape images and evening scene images, and representative samples of scenes other than these (for example, night scenes) are not included.

FIG. 25C is an explanatory diagram of representative samples that have been projected onto a normal line. The normal line is made horizontal to show the positional relationships of the representative samples that have been projected onto the normal line so that the landscape image representative samples are positioned on the left side of FIG. 25C or, in other words, so that the non-landscape image representative samples are positioned on the right side of FIG. 25C.

Next, the printer-side controller 20 defines five divisions on the normal line. A first division to a fifth division are defined in FIG. 25C. Each division is defined so as to have a predetermined length. And the five divisions are defined so that the position of the intersection point between the normal line and the border (F_ls(x)=0) in FIG. 25B is on the border of two divisions. Here, the position of intersection point between the normal line and the border (F_ls(x)=0) in FIG. 25B corresponds to the boundary between the third division and the fourth division. It should be noted that a plurality of representative samples are present in each division.

Next, the printer-side controller 20 extracts image data of the representative samples positioned in a center of each division. Here, image data of the representative sample of the cluster B is extracted from the first division. Similarly, image data of the representative samples of the clusters D, E, J, and I are extracted from the second, third, fourth, and fifth divisions respectively. At this time, representative samples that are set in the default settings as belonging to a landscape scene are extracted from the first to third divisions. And representative samples that are set in the default settings as belonging to an evening scene are extracted from the fourth and fifth divisions. The extracted image data can be considered as representatives of each division.

The printer-side controller 20 uses the extracted image data and displays the settings screen 163 on the display section 16 of the printer 4. The image data of the representative sample of the cluster B that has been extracted from the first division is used in displaying the image LS1 of FIG. 23. Similarly, the image data of the representative samples of the clusters D, E, J and I are used in displaying the images LS2, LS3, LS4, and LS5 of FIG. 23 respectively.

Furthermore, since the position of an intersection point between the normal line and the border (F_ls(x)=0) in FIG. 25B corresponds to the boundary between the third division and the fourth division, the printer-side controller 20 displays the border setting bar 163A between the image LS3 (the image of the representative sample extracted from the third division) and the image LS4 (the image of the representative sample extracted from the fourth division) in FIG. 23. In this regard, since the images LS1 to LS3 are landscape images and the images LS4 and LS5 are evening scene images, the border setting bar 163A is displayed between the landscape images and the evening scene images.

As described above, in the present embodiment the position of the representative samples are projected onto a normal line of the border and the representative samples to be extracted are determined based on the positions of the representative samples projected onto the normal line. In this way, in the present embodiment, the five images of the representative samples are displayed so that images having larger values of the discriminant equation F_ls(x) are further to the left. In other words, the five images of the representative samples can be displayed so that they are aligned from the left in order of higher certainty factors for belonging to a landscape scene.

And since the settings screen 163 of FIG. 23 is displayed as described above, the representative samples of landscape images are displayed on the left side of the border setting bar 163A under the default settings. Furthermore, the representative samples of evening scene images are displayed on the right side of the border setting bar 163A under the default settings. Then, of these five images, images further to the left are images in which characteristics of a landscape appear more strongly, and images further to the right are images in which characteristics of an evening scene appear more strongly. In other words, the five images LS1 to LS5 are displayed so that the five images transition from landscape images to evening scene images in order from left to right. For this reason, images that are displayed near the border setting bar 163A are images for which judgment of whether the image is a landscape image or an evening scene image tends to vary according to the preference of the user.

In the above description, description was given regarding the topmost five images of the settings screen 163 (landscape images and evening scene images), but the printer-side controller 20 carries out equivalent processing for the other scenes as well. In this way, the printer-side controller 20 can also display images other than the images LS1 to LS5 of the settings screen 163 in FIG. 23.

Processing After the Border has Been Set at the Settings Screen 163 (Part 1)

Next, description is given regarding processing after the user moves the border setting bar 163A one place to the left and sets it between the image LS2 and the image LS3 as shown in FIG. 23.

After the border setting bar 163A is moved, the image LS3 (which is the representative sample image of the cluster E and an image that represents the third division), which is a landscape image under the default settings, becomes positioned on the right side of the border setting bar 163A between the border setting bar 163A and the image LS4, which is an evening scene image under the default settings. Since the user has moved the border setting bar 163A from between the image LS3 and the image LS4 to between the image LS2 and the image LS3, it can be assumed that the user thinks that the learning samples belonging to the clusters E and F, which belong to the third division shown in FIG. 25C, are not landscape images (here it can be assumed that the user thinks the learning samples belonging to the clusters E and F are evening scene images)

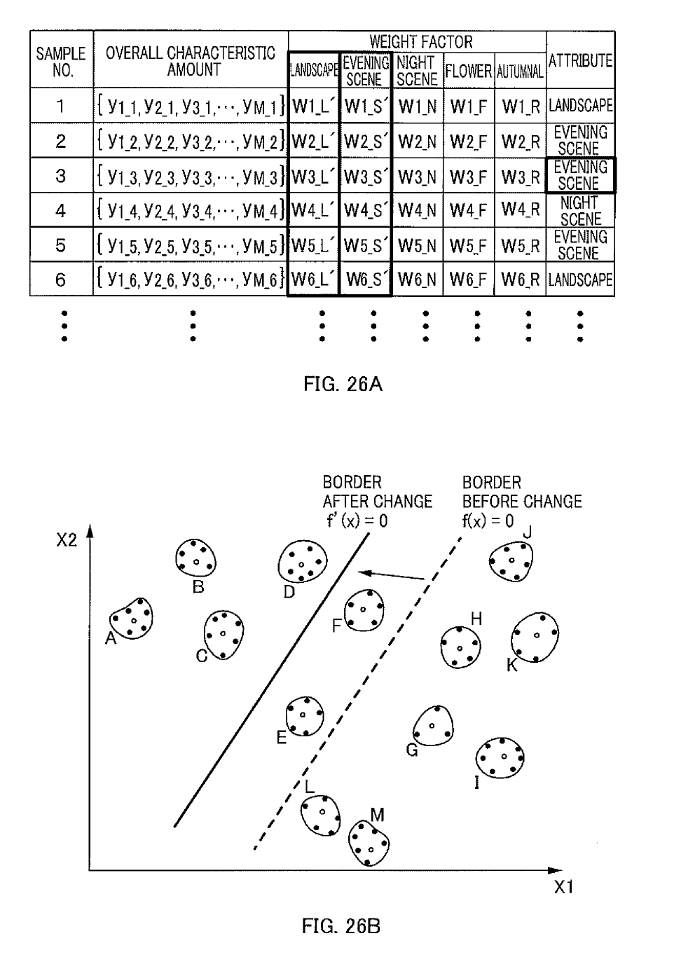

FIG. 26A is an explanatory diagram of a data group after being changed. FIG. 26B is an explanatory diagram of a border after being changed. Description is given below using these diagrams regarding the processing of the printer-side controller 20 after the settings changes.

First, the printer-side controller 20 changes from landscape to evening scene the attribute information of the learning samples belonging to the clusters E and F. For example, say the sample number 3 in FIG. 24A belongs to the cluster E or cluster F, then the attribute information is changed from landscape to evening scene as shown in FIG. 26A.

In the present embodiment, not only is the attribute information of the representative sample of the cluster E changed, but the attribute information of all the learning samples belonging to the cluster E are changed. In this way, the attribute information of learning samples having similar properties to the image that the user wishes not to belong to landscape can be changed collectively by a single operation of the user.

Furthermore, in the present embodiment, not only is the attribute information of the representative sample of the cluster E changed, but the attribute information of all the learning samples (for example, the cluster F) belonging to the third division are changed. In this way, the attribute information of learning samples that are apart from the border to a similar extent as the image that the user wishes not to belong to landscape can be changed collectively by a single operation of the user.

Next, based on the overall characteristic amounts and the attribute information after changing, the printer-side controller 20 carries out relearning of the support vector machine and changes the border as shown in FIG. 26B. In other words, based on the overall characteristic amounts and the attribute information after changing, the printer-side controller 20 carries out relearning and changes the weight factors w of FIG. 24A as shown in FIG. 26A. Here, the border after changing is expressed as f′(x)=0 and the weight factor after changing is expressed as w′. It should be noted that the arithmetic processing of relearning is the same as that of an ordinary support vector machine, and therefore description of relearning is omitted.

It should be noted that when the position of the topmost row border setting bar 163A is changed as shown in FIG. 23, the weight factor of landscape and the weight factor of evening scene are changed, so that the border f(x) of the landscape identifying section 51L and the border f(x) of the evening scene identifying section 51S are changed. When the border f(x) of the landscape identifying section 51L is changed by relearning, relearning is carried out using learning samples so that landscape and non-landscape (evening scene, night scene, flower, and autumnal) can be separated in the attribute information after changing. When the border f(x) of the evening scene identifying section 51S is changed by relearning, relearning is carried out using learning samples so that evening scene and non-evening scene (landscape, night scene, flower, and autumnal) can be separated in the attribute information after changing.

The weight factor w (or w′) becomes zero if it does not contribute to determining the border. For this reason, weight factors w that were zero in FIG. 24A may sometimes have a value other than zero due to a change. Conversely, weight factors w that held a value other than zero in FIG. 24A may sometimes become zero due to a change. This is why even the data of learning samples that do not contribute to determining the border under the default settings are also stored in the data group of FIG. 24A.

When the landscape identifying section 51L determines whether or not an image to be identified belongs to a landscape scene, the landscape identifying section 51L calculates the value of the discriminant equation of the aforementioned Formula 1 (the value of the discriminant equation f′(x) after changing) based on the overall characteristic amounts of the learning samples of the data group of FIG. 26B and the weight factor w′ of landscape (weight factors having the suffix L) after changing. It should be noted that the landscape identifying section 51L calculates the value of the discriminant equation of the aforementioned Formula 1 excluding learning samples whose weight factors w′ are zero. In this way, the speed of calculation becomes faster than a case where the value of the discriminant equation is obtained using all the learning samples.

By using the discriminant equation f′(x) after changing, identification processing reflecting the preferences of the user can be carried out. For example, say if the image LS3 (see FIG. 23) is a reddish landscape image and the image to be identified is a reddish landscape image, it would be difficult to judge that the image to be identified belongs to a landscape scene. In other words, if the cluster E (see FIG. 26B) is constituted by learning samples of reddish landscape images and the image to be identified is a reddish landscape image, then it would be difficult to judge that the image to be identified belongs to a landscape scene.

In the present embodiment, a settings change that matches the preferences of the user can be carried out easily. Suppose that a multitude of images of learning samples are displayed one by one and the user has to determine the scene of the image of the displayed learning samples one by one, then the user would have to carry out the determining operation numerous times, making it inconvenient.

It should be noted that in the foregoing description, description was given regarding a case where the user moved the border setting bar 163A one place to the left. In contrast to this, suppose that in a case where the user has moved the border setting bar 163A one place to the right, the image LS4 (which is the representative sample image of the cluster J and an image that represents the fourth division), which is an evening scene image under the default settings, becomes positioned on the left side of the border setting bar 163A between the border setting bar 163A and image LS3, which is a landscape image under the default settings. In a case such as this, the printer-side controller 20 changes from evening scene to landscape the attribute information of the learning samples belonging to the clusters J, H, and G belonging to the fourth division, and carries out relearning of the support vector machine based on the overall characteristic amounts and the attribute information after changing, thereby changing the border. In this case also, the identification processing reflecting the preferences of the user can be carried out.

Processing After the Border has Been Set at the Settings Screen 163 (Part 2)

In the foregoing description, description was given regarding a case where the position of only one border setting bar was changed, but next, description is given regarding a case where the positions of two border setting bars are changed.

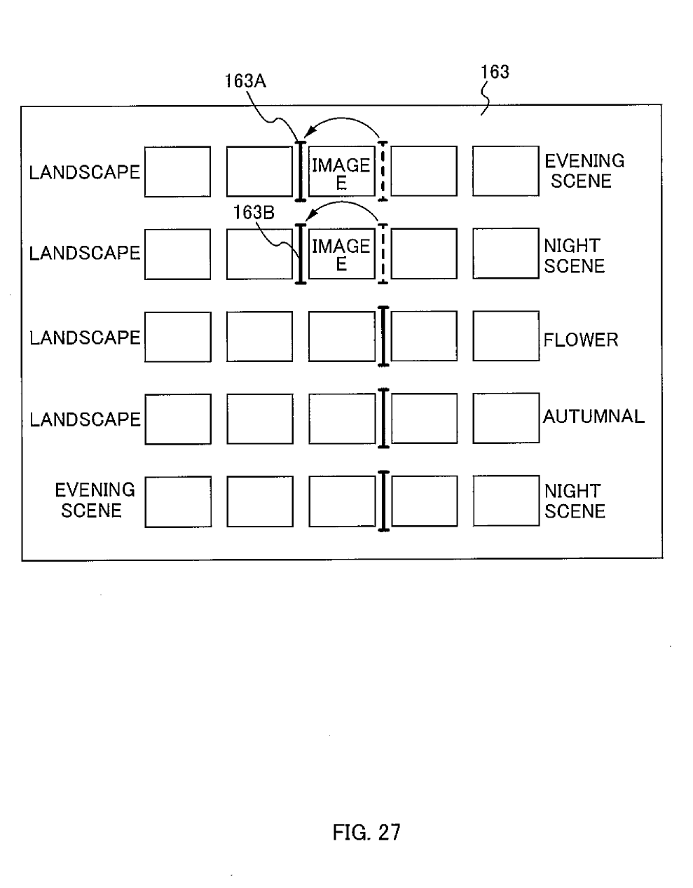

FIG. 27 is an explanatory diagram showing how positions of two border setting bars are changed. As a result of the settings screen 163 being displayed on the display section 16 according to processing that has already been described, the image of the representative sample of the cluster E is displayed in the position of the image LS3 among the five images LS1 to LS5 (see FIG. 23) displayed on the topmost row. Furthermore, as a result of a similar processing, the image of the representative sample of the cluster E is displayed in the position of the image LN3 among the five images LN1 to LN5 (see FIG. 23) displayed on the second row.

As shown in FIG. 27, suppose that the user moves the border setting bar 163A of the topmost row one place to the left and also moves a border setting bar 163B on the second row one place to the left. In this case, when “the image E is an evening scene image” is set due to the settings change of the topmost row border setting bar 163A, and “the image E is a night scene image” is set due to the settings change of the second row border setting bar 163B, a contradiction arises. In a case where the positions of the border setting bars are changed in this manner, a contradiction sometimes arises when the images sandwiched by the border setting bars before and after changing are handled as “is a image”.

For this reason, in a case where the positions of two border setting bars have been changed as in FIG. 27, by assuming that “the image E is not a landscape image” due to the settings change of the topmost row border setting bar 163A and that “the image E is not a landscape image” due to the settings change of the second row border setting bar 163B, a contradiction does not arise. In a case where the positions of the border setting bars are changed in this manner, the images sandwiched by the border setting bars before and after changing are handled as “is not a ______ image” (it should be noted that this is the same in a case where one border setting bar has its position changed).

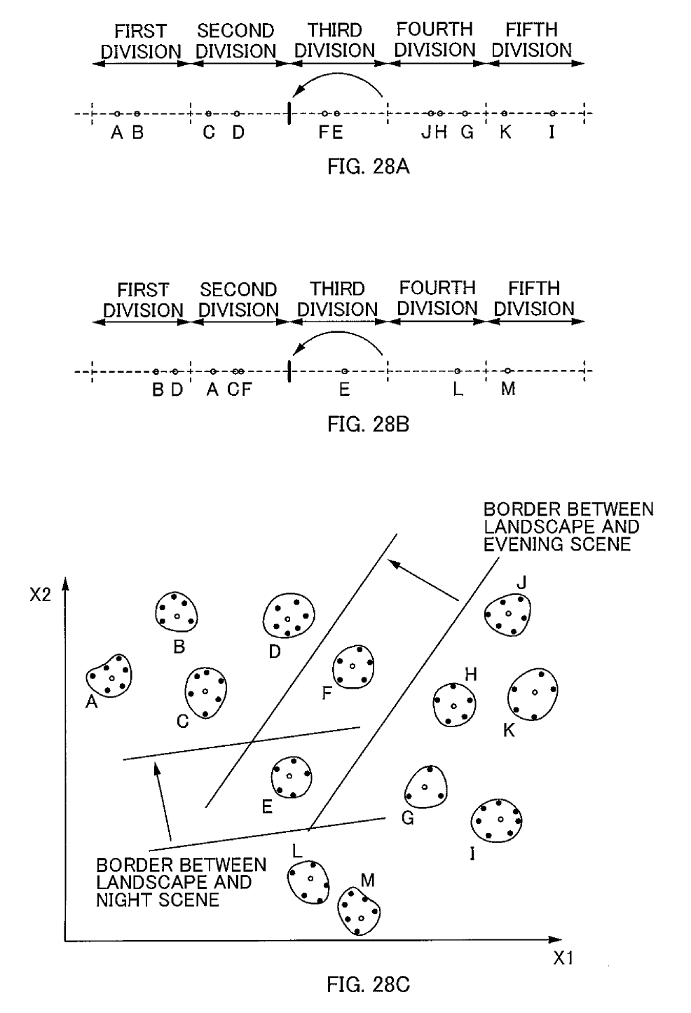

FIG. 28A is an explanatory diagram of a result of changing the position of the topmost row border setting bar 163A. Since the image sandwiched by the border setting bar before and after changing is handled as “is not a landscape image” as a result of the topmost row border setting bar 163A being moving one place to the left, the attribute information of the learning samples belonging to the clusters E and F are no longer landscape.

FIG. 28B is an explanatory diagram of a result of changing the position of the second row border setting bar 163B. Since the image sandwiched by the border setting bar before and after changing is handled as “is not a landscape image” as a result of the second row border setting bar 163B being moving one place to the left, the attribute information of the learning samples belonging to the cluster E are no longer landscape.

Next, description is given regarding to which scene the attribute information of the clusters E and F should be changed. FIG. 28C is a schematic diagram of a result of changing the positions of the two level border setting bars.

As shown in FIGS. 28A to FIG. 28C, the cluster F is influenced by only changes to the setting of the topmost row border setting bar 163A and is not influenced by changes to the setting of the second row border setting bar 163B. For this reason, the printer-side controller 20 changes to evening scene the attribute information of the learning samples belonging to the cluster F.

As shown in FIGS. 28A to FIG. 28C, the cluster E is influenced not only by changes to the setting of the topmost row border setting bar 163A, but is also influenced by changes to the setting of the second row border setting bar 163B. For this reason, there is a problem as to whether the attribute information of the learning samples belonging to the cluster E should be changed to evening scene or to night scene. Consequently, the printer-side controller 20 first extracts a representative sample closest to the representative sample of the cluster E in the space of FIG. 28C and that is a representative sample of a scene other than landscape (a representative sample of the clusters G to M). Here, a representative sample of the cluster L is extracted. Then, the printer-side controller 20 changes the attribute information of learning samples belonging to the cluster E so as to be the same attribute information as the attribute information of the extracted representative sample. That is, the attribute information of the learning sample belonging to the cluster E is changed to night scene.

It should be noted that processing after the changing of the attribute information is as has already been described. Namely, based on the overall characteristic amounts and the attribute information after changing, relearning of the support vector machine is carried out and the discriminant equation is changed (the border is changed) by changing the weight factor w.

According to the above-described processing, even in a case where the positions of two border setting bars are changed, the identification processing reflecting the preferences of a user can be carried out without contradicting the settings of the user.

### MODIFIED EXAMPLE OF THE SECOND EMBODIMENT

In this modified example, the discriminant equation is changed and a positive threshold is also changed. Here also description is given regarding processing after the user moves the border setting bar 163A one place to the left and sets it between the image LS2 and the image LS3.

First, the printer-side controller 20 changes from landscape to evening scene the attribute information of the learning samples belonging to the clusters E and F. The processing here is the same as in the second embodiment, which has already been described.

Next, based on the overall characteristic amounts and the attribute information after changing, the printer-side controller 20 carries out relearning of the support vector machine and changes the border (changes the discriminant equation). The processing here also is the same as in the first embodiment. Here, this means that the discriminant equation of the landscape identifying section 51L and the discriminant equation of the evening scene identifying section 51S are changed.

Next, the printer-side controller 20 uses evaluation samples (note that the attribute information of the evaluation samples are changed in response to the setting of the border setting bar 163A by the user) and generates a graph of Precision (see FIG. 9) of an identification result according to the discriminant equation f′(x) after changing. Then it specifies a positive threshold so that the regenerated Precision becomes 97.5%. In this way, the settings changes of the landscape identifying section 51L and the evening scene identifying section 51S are finished.

When the landscape identifying section 51L determines whether or not an image to be identified belongs to a landscape scene, the landscape identifying section 51L calculates the value of the discriminant equation based on the overall characteristic amounts of the image to be identified. Then, if the value of the discriminant equation is greater than the positive threshold after changing (yes at S204 in FIG. 7), then the landscape identifying section 51L determines that the image to be identified belongs to a landscape scene and sets a positive flag (S205).

In a same manner as in the above-described second embodiment, with this modified example also, an identification processing reflecting the preferences of the user can be carried out.

### Other Embodiments

A printer or the like has been described above as an embodiment of the invention. However, the foregoing embodiments are for the purpose of elucidating the invention and are not to be interpreted as limiting the invention. The invention can of course be altered and improved without departing from the gist thereof and includes functional equivalents. In particular, embodiments described below are also included in the invention.

Regarding the Printer

In the above-described embodiments, the printer 4 performs the scene identification processing, but it is also possible that the digital still camera 2 performs the scene identification processing. Moreover, an image identifying apparatus that performs the above-described scene identification processing is not limited to the printer 4 and the digital still camera 2. For example, an image identifying apparatus such as a photo storage device for storing a large volume of image files may perform the above-described scene identification processing. Naturally, a personal computer or a server located on the Internet may also perform the above-described scene identification processing.

It should be noted that a program that executes the above-described scene identification processing in a scene identifying apparatus is also included within the scope of the invention.

Regarding Support Vector Machines

The above-described sub-identifying sections 51 and sub-partial identifying sections 61 employ the identifying method using support vector machines (SVM). However, the method for identifying whether or not the image to be identified belongs to a specific scene is not limited to methods using the support vector machines. For example, it is also possible to employ pattern recognition techniques, such as a neural network.

Regarding Scene Identification

In the foregoing embodiments, the sub-identifying sections 51 and the sub-partial identifying sections 61 identify whether or not an image indicated by image data belongs to a specific scene. However, the invention is not limited to identifying scenes and may also identify whether or not the image belongs to a class of some kind. For example, it may perform identification as to whether or not an image indicated by image data is in a specific patterned shape.

Although the preferred embodiment of the invention has been described in detail, it should be understood that various changes, substitutions and alterations can be made therein without departing from spirit and scope of the inventions as defined by the appended claims.

What is claimed is:

1. An identifying method, in which learning is carried out using a learning sample and, based on a learning result, identification is performed as to whether or not a target of identification belongs to a certain class, comprising:
extracting a learning sample belonging to the certain class and a learning sample not belonging to the certain class,
displaying a plurality of the extracted learning samples arranged on a display section, as well as displaying a mark between the learning sample belonging to the certain class and the learning sample not belonging to the certain class, and displaying the mark between a different pair of the learning samples by moving a position of the mark in response to an instruction of a user,
changing an attribute information that indicates a class to which the learning sample belongs in response to the position of the mark determined by the user, and
identifying whether or not a target of identification belongs to the certain class based on a result of relearning using the learning sample of which the attribute information has been changed.

2. An identifying method according to claim 1,
wherein the extracting includes extracting a learning sample belonging to the certain class and a learning sample belonging to a different class from the certain class, and
an identification processing that identifies whether or not a target of identification belongs to the certain class and an identification processing that identifies whether or not a target of identification belongs to the different class are changed by the relearning.

3. An identifying method according to claim 2,
wherein in the changing an attribute,
in a case where the position of the mark has been determined in a state in which the learning sample belonging to the certain class is positioned between the mark and the learning sample belonging to the different class, the attribute information of the learning sample belonging to the certain class positioned between the mark and the learning sample belonging to the different class is changed so as to be not belonging to the certain class, and
in a case where the position of the mark has been determined in a state in which the learning sample belonging to the different class is positioned between the mark and the learning sample belonging to the certain class, the attribute information of the learning sample belonging to the different class positioned between the mark and the learning sample belonging to the certain class is changed so as to be not belonging to the different class.

4. An identifying method according to claim.3,
wherein the extracting includes extracting a learning sample as a representative from each clusters that have undergone clustering, and
the changing an attribute includes, in a case the attribute information of a representative learning sample is changed, the attribute information of a learning sample belonging to a same cluster as that learning sample is also changed.

5. An identifying method according to claim 2,
wherein the learning sample is projected onto a normal line of a hyperplane that separates a learning sample belonging to the certain class and a learning sample belonging to the different class, and a learning sample to be extracted is determined based on a position of the learning sample that has been projected onto the normal line.

6. An identifying method according to claim 1,
wherein the identification processing identifies whether or not the target of identification belongs to the certain class based on a hyperplane that separates a space, and
in the extracting, the learning sample is projected onto a normal line of the hyperplane, and a learning sample to be extracted is determined based on a position of the learning sample that has been projected onto the normal line.

7. A storage medium having a program stored thereon, the program causing an identifying apparatus, in which learning is carried out using a learning sample and, based on a learning result, performs identification as to whether or not a target of identification belongs to a certain class, to perform:
extracting a learning sample belonging to the certain class and a learning sample not belonging to the certain class,
displaying a plurality of the extracted learning samples arranged on a display section as well as, displaying a mark between the learning sample belonging to the certain class and the learning sample not belonging to the certain class, and displaying the mark between a different pair of the learning samples by moving a position of the mark in response to an instruction of a user,
changing attribute information that indicates a class to which the learning sample belongs in response to the position of the mark determined by the user, and
identifying whether or not the target of identification belongs to the certain class based on a result of relearning using the learning sample of which the attribute information has been changed.
